(19) United States
(12) Patent Application Publication
(10) Pub. No.: US 2009/0045535 A1
(43) Pub. Date: Feb. 19, 2009

(54) Method of producing organic particles and production apparatus usable for the same

(76) Inventors: Yousuke Miyashita, Kanagawa (JP); Takayuki Kusano, Kanagawa (JP); Yasuyuki Izumi, Kanagawa (JP)

Correspondence Address: BIRCH STEWART KOLASCH & BIRCH, PO BOX 747, FALLS CHURCH, VA, 22040-0747, US

(21) Appl. No.: 11/920,082

(22) PCT Filed: May 8, 2006
(86) PCT No.: PCT/JP2006/309270

§ 371 Date: Nov. 8, 2007

(30) Foreign Application Priority Data
May 9, 2005 (JP) 2005-136748
May 9, 2005 (JP) 2005-136749
May 9, 2005 (JP) 2005-136750
May 9, 2005 (JP) 2005-136751
Jul. 22, 2005 (JP) 2005-213035
Jul. 22, 2005 (JP) 2005-213060
Jul. 22, 2005 (JP) 2005-213088
Jul. 22, 2005 (JP) 2005-213121

(51) Int. Cl. B01F 7/00; B01F 13/08; B01F 15/02; B29B 9/00

(52) U.S. Cl. 264/8; 366/343; 366/300; 366/195

(57) ABSTRACT

A method of producing organic particles, containing: mixing a poor solvent for an organic material with a solution of the organic material in a good solvent, which is conducted by any among:

[a] containing: feeding the poor solvent and the solution into a stirring vessel through liquid feed ports, respectively; mixing those under stirring in the vessel, to form the particles; and taking out the resultant liquid mixture containing the particles formed;

[b] containing: providing a stirring zone in part of a container filled with the poor solvent; feeding the solution into the stirring zone; mixing the poor solvent and the solution under stirring, to form the particles; and making the particles flow out of the stirring zone into another zone; and

[c] containing: mixing the poor solvent and the solution under applying shearing force.

### TECHNICAL FIELD

The present invention relates to a method of producing organic particles and a production apparatus usable for the method. In particular, the present invention relates to a method that can stably produce organic particles in large quantities by a reprecipitation method, and a production apparatus usable for the method. Further, the present invention relates to a method of producing organic particles which can be obtained by concentrating organic particles that have been produced by a reprecipitation method.

### BACKGROUND ART

In recent years, studies to reduce the size of particles have progressed. In particular, intensive study has been conducted to reduce the particles into nanometer sized (for example, in the range of 10 to 100 nm) which can hardly be realized by methods of pulverization and others. Further, attempts have been made not only to provide particles whose particle sizes are reduced to be of the order of nanometers, but also to form them having monodispersity.

Such nanometer-sized fine-particles are distinguished from vigorously bulk particles (bigger in size) and from molecules and atoms (smaller in size). That is, the nanometer-sized fine-particles are categorized in a new field between them stated above in size. Thus, such nanoparticles are considered to show unexpected new properties over the conventional sized particles. It is also possible to stabilize the properties of nanoparticles if the monodispersity can be improved. Thus, nanoparticles having such potential are attracting attention in various fields, and they have been studied vigorously in a variety of fields such as biochemistry, new materials, electronic elements, light-emitting display devices, printing, and medicine.

In particular, organic nanoparticles made of an organic compound involve great potential as a functional material, because the organic compounds, per se, can be modified diversely. For example, polyimide has been utilized in various fields because of, for example, the following reasons: polyimide is a chemically and mechanically stable material owing to, for example, its heat resistance, solvent resistance, and mechanical characteristics, and is excellent in electrical insulating property. Further, the field of applications of polyimide has been additionally widened by combining the properties and shape of polyimide with finesse. For example, there has been proposed that polyimide is used as an additive for powder toner for image formation (see JP-A-11-237760 (“JP-A” means unexamined published Japanese patent application)).

Further, among the organic nanoparticles, organic pigments are used in such applications as painting, a printing ink, an electrophotographic toner, an inkjet ink, and a color filter, and thus the organic pigments are now important materials essential for our everyday life. Particularly, organic pigments are demanded in high-performance with practical importance including pigments for an inkjet ink and a color filter.

Dyes have been used as the colorants for inkjet inks, but pigments are employed recently for solving problems of the dyes in water resistance and light stability. Images obtained by using a pigment ink have an advantage that they are superior in light stability and water resistance to the images formed by using a dye-based ink. However, it is difficult to give fine particles having high monodispersity and having nanometer size, so that the pigment particles can penetrate into the pores on paper surface. As a result, such an image has a problem that the adhesiveness thereof to paper is weaker.

Further, the increase in the number of pixels of a digital camera, there is increased need for reduction in thickness of the color filter for use in optical elements such as a CCD sensor and a display device. Organic pigments have been used in color filters whose thickness depends significantly on the particle diameter of the organic pigment to be used therein, and hence it is needed to produce fine particles in a nanometer sized, with having stability in a monodispersed state.

As for production methods of organic nanoparticles, studies are made on, for example, a gas-phase method (a method of sublimating a sample under inert gas atmosphere and depositing particles on a substrate), a liquid-phase method (a reprecipitation method for obtaining fine particles, for example, by injecting a sample that has been dissolved in a good solvent, into a poor solvent of which the stirring condition and the temperature are controlled), and a laser-ablation method (a method of reducing the size of particles by laser-ablation to a sample dispersed in a solution with laser irradiated thereto). There are also reports on an attempt of preparation of monodispersed nanoparticles having a desired particle size by those methods. Of those, the reprecipitation method has been attracting attention, since it is a method of producing organic particles excellent in its simplicity and productivity (see JP-A-06-79168, JP-A-2004-91560, JP-T-2002-092700 (“JP-T” means published searched patent publication)).

Organic particles can be produced with the reprecipitation method even at room temperature. However, the size of each of the particles depends on temperature to a large extent. In particular, the stable production of organic pigment particles requires sufficient cooling of a poor solvent and the mass production of such particles on an industrial scale requires a cooling plant, resulting in a significant increase in cost. Accordingly, there has been a demand for a method in which temperature control can be relatively easily performed and with which organic fine-particles are stably produced at temperatures around room temperature.

Meanwhile, examples of an industrial stirring device include devices described in JP-A-10-43570 and JP-B-55-10545 (“JP-B” means examined Japanese patent publication). However, each of the devices is intended for the production of silver halide particles, and no application examples where organic fine-particles are precipitated and formed have been reported for the devices.

Further, various mixing devices for emulsification and dispersion have been known as industrial stirring devices (see, for example, “Liquid mixing technique for new material” by Koji Takahashi, Industrial Publishing & Consulting, Inc., 1994). In the industries of, for example, food, medicine, cosmetics, and photographic light-sensitive materials, emulsification and dispersion have become techniques indispensable for imparting functions to a product, and have been researched and developed. It is important for an emulsion as a liquid-liquid mixture to be uniformly mixed, from the viewpoints of performance and stability. A reduction in size of an emulsified particle is effective for the uniform mixing, and attempts have been made to apply a physical shearing force to an emulsified particle to reduce the size of the particle. Further, it is also important for a dispersion product as a solid-liquid mixture to be uniformly mixed. The uniform mixing requires a reduction in size of a dispersed particle, and attempts have been made to apply a physical shearing force to a dispersed particle to reduce the size of the particle. However, those stirring techniques are intended merely for reducing a size of an emulsified particle or of a bulk particle in a dispersion product unlike the reprecipitation method.

Further, in the reprecipitation method, the resultantly-prepared organic particles are obtained in a state of being dispersed in a solvent. The industrial utilization of the particles requires that the concentration of the particles be properly adjusted to give a concentrated product or the particles be separated as fine particles. However, no sufficient research has been conducted on each of the concentration and the separation. For example, JP-A-2004-181312 discloses a concentration method involving adding an evaporation-accelerating liquid to an organic particle-containing aqueous dispersion followed by distillation. However, in consideration of the application of the method to an organic particle-containing aqueous dispersion produced by the reprecipitation method, when a good solvent for an organic material has a boiling point higher than that of water, the following phenomenon may occur: only water evaporates, so the concentration of the good solvent increases, and the particle diameter of an organic particle increases during concentration.

JP-A-2004-292632 discloses a method involving adding, to a dispersion containing fine particles, an ionic liquid that is substantially insoluble in the dispersion medium of the dispersion and concentrating the fine particles in the ionic liquid. However, an organic particle dispersion liquid cannot be sufficiently concentrated to a desired concentration with the method alone in some cases.

JP-A-2004-43776 discloses a production example in which a fine pigment-dispersed product is concentrated by filtration under reduced pressure. However, the particle diameter of the resultant pigment in the dispersion product increases owing to the concentration in many cases. Further, the production example is applicable only to the case where the dispersion product is produced on a relatively small scale, and may be unable to maintain a given particle diameter, monodispersity, and redispersibility upon increase in production scale.

Even when desired particles can be prepared in a dispersion liquid by the reprecipitation method or the like, the particles cannot be made into a product in the case where a particle size changes or monodispersity deteriorates during concentration, and separation/collection steps. Further, the particles cannot be put into practical use in the case where any such step requires a large cost.

### DISCLOSURE OF INVENTION

According to the present invention, there is provided the following means:

(1) A method of producing organic particles, comprising: mixing a poor solvent for an organic material with a solution of the organic material dissolved in a good solvent, thereby to form particles of the organic material in a resultant liquid mixture, said poor solvent being compatible with the good solvent, wherein the formation of the organic particles is conducted by any of the following processes a, b, and c:

[a] a process comprising: feeding the poor solvent and the solution of the organic material into a stirring vessel through predetermined numbers of liquid feed ports, respectively; mixing the poor solvent and the solution of the organic material under stirring in the stirring vessel, to form said organic particles; and taking out the liquid mixture containing the organic particles formed via the mixing under stirring;

[b] a process comprising: providing a stirring zone in part of a container filled with the poor solvent; feeding the solution of the organic material into the stirring zone; mixing the poor solvent and the solution of the organic material in the stirring zone under stirring, to form said organic particles; and making the organic particles flow out of the stirring zone into another zone of the container; and

[c] a process comprising: mixing the poor solvent and the solution of the organic material under the condition where a shearing force is applied.

(2) The method of producing organic particles according to the above item (1), wherein the process a includes: providing a pair of stirring blades placed at two opposing sites in the stirring vessel so that the stirring blades are distant from each other; rotating the stirring blades in directions opposite to each other, to mix the poor solvent and the solution of the organic material under stirring; and controlling a state where a liquid is stirred in the stirring vessel.
(3) The method of producing organic particles according to the above item (2), wherein an external magnet is placed on the outside of the wall of the stirring vessel close to the respective stirring blade, a magnetic coupling having no penetrating axis is formed between the external magnet and the respective stirring blade, and the respective stirring blade is rotated by rotating the external magnet.
(4) The method of producing organic particles according to the above item (1), wherein the process b includes: providing the stirring zone with a first stirring means and a second stirring means; quickly mixing the poor solvent and the solution of the organic material in the stirring zone with the first stirring means; and immediately making said organic particles formed flow out of the stirring zone with the second stirring means.
(5) The method of producing organic particles according to the above item (1), wherein the mixing under the condition where a shearing force is applied in the process c is performed with a dissolver stirring machine.
(6) The method of producing organic particles according to the above item (1), wherein the mixing under the condition where a shearing force is applied in the process c is performed with a stirrer provided with a turbine capable of rotating and an immobilized stator.
(7) The method of producing organic particles as described in any one of the above items (1) to (6), wherein the poor solvent for the organic material is a solvent selected from the group consisting of aqueous solvents, alcohol compound solvents, ketone compound solvents, ether compound solvents, ester compound solvents, and mixed solvents thereof.
(8) The method of producing organic particles as described in any one of the above items (1) to (7), wherein the good solvent for the organic material is a solvent selected from the group consisting of aqueous solvents, alcohol compound solvents, ketone compound solvents, ether compound solvents, sulfoxide compound solvents, ester compound solvents, amide compound solvents, and mixed solvents thereof.
(9) The method of producing organic particles as described in any one of the above items (1) to (8), wherein the organic material is an organic pigment.
(10) The method of producing organic particles as described in any one of the above items (1) to (9), wherein the organic particles have a number average particle diameter of 1 μm or less.
(11) An apparatus of producing organic particles, in which a solution of an organic material dissolved in a good solvent is mixed with a poor solvent for the organic material, thereby to form particles of the organic material in a resultant liquid mixture, said poor solvent being compatible with the good solvent, wherein the apparatus has any of the following means A and B:

[A] means comprising: predetermined numbers of liquid feed ports through which the poor solvent and the solution of the organic material dissolved in the good solvent are made to flow, respectively; a liquid discharge port for discharging a liquid that has been subjected to the stirring; and stirring means; and

[B] means comprising: a container capable of containing the poor solvent; a mixing chamber which is provided in the container and the inside of which is capable of being filled with the poor solvent; and stirring means for mixing and stirring the poor solvent and the solution of the organic material fed into the mixing chamber, the stirring means being provided in the mixing chamber.

(12) The apparatus of producing organic particles according to the above item (11), wherein the stirring means in the means A is a pair of stirring blades, the stirring blades being placed at two opposing sites distant from each other in a stirring vessel, and the stirring blades rotating in directions opposite to each other, to control a state where a liquid is stirred in the stirring vessel.
(13) The apparatus of producing organic particles according to the above item (12), which has: an external magnet which is placed on the outside of the wall of the stirring vessel close to the respective stirring blade and which forms a magnetic coupling having no penetrating axis with respect to the respective stirring blade; and driving means for rotating the respective stirring blade by rotating the external magnet, the driving means being deployed outside the stirring vessel.
(14) The apparatus of producing organic particles according to the above item (11), wherein the means B has: a first stirring means for quickly mixing the poor solvent and the solution of the organic material inside the mixing chamber; and a second stirring means for immediately discharging the resultantly-formed organic particles, to the outside of the mixing chamber.
(15) The apparatus of producing organic particles according to any one of the above items (11) to (14), wherein the organic particles have a number average particle diameter of 1 μm or less.
(16) A method of producing organic particles, comprising: mixing a poor solvent for an organic material with a solution of the organic material dissolved in a good solvent, thereby to form particles of the organic material in a resultant liquid mixture, said poor solvent being compatible with the good solvent; and concentrating the liquid mixture, thereby to obtain the organic particles, wherein the concentration is conducted by removing (I) a solvent in the liquid mixture or (II) a solvent of a concentrated extract liquid obtained by concentrating and extracting the organic particles from the liquid mixture with an extraction solvent, by at least one method selected from among centrifugal separation and drying under heat and reduced pressure.
(17) The method of producing organic particles as described in the above item (16), wherein the organic particles have a number average particle diameter of 1 μm or less.
(18) The method of producing organic particles as described in the above item (16) or (17), wherein the poor solvent for the organic material is a solvent selected from the group consisting of aqueous solvents, alcohol compound solvents, ketone compound solvents, ether compound solvents, ester compound solvents, and mixtures thereof.
(19) The method of producing organic particles according to any one of the above items (16) to (18), wherein the good solvent for the organic material is a solvent selected from the group consisting of aqueous solvents, alcohol compound solvents, ketone compound solvents, ether compound solvents, sulfoxide compound solvents, ester compound solvents, amide compound solvents, and mixtures thereof.
(20) The method of producing organic particles according to any one of the above items (16) to (19), wherein the extraction solvent is an ester compound solvent.
(21) The method of producing organic particles according to any one of the above items (16) to (20), wherein the organic material is an organic pigment.

Other and further features and advantages of the invention will appear more fully from the following description, taking the accompanying drawings into consideration.

### BRIEF DESCRIPTION OF DRAWINGS

FIG. 1-1 is a front view schematically showing an example of a dissolver stirring blade that can be used in the production method of the present invention.

FIG. 1-2 is a photograph, as an alternative to a figure, showing an example of the dissolver stirring blade that can be used in the production method of the present invention.

FIG. 1-3 is a sectional view schematically showing an example of a stirring portion, which can be used in the production method of the present invention, and which is constituted of a turbine capable of rotating and an immobilized stator placed around the turbine with a slight gap.

FIG. 2-1 is a sectional view schematically showing a preferred embodiment of the production apparatus of the present invention.

FIG. 2-2 is a sectional view schematically showing another preferred embodiment of the production apparatus of the present invention.

FIG. 3-1 is a sectional view schematically showing still another embodiment of the production apparatus of the present invention.

FIG. 3-2 is a partially enlarged sectional view schematically showing a mixing chamber as a preferred embodiment of the production apparatus shown in FIG. 3-1.

FIG. 3-3 is a partially enlarged sectional view schematically showing a mixing chamber as another preferred embodiment of the production apparatus shown in FIG. 3-1.

### BEST MODE FOR CARRYING OUT THE INVENTION

Hereinafter, the production method and apparatus of the present invention will be described in detail.

For an organic material that can be used in the production method of the present invention, there is no particular limitation as long as the organic material can be formed into organic particles by a reprecipitation method. Examples of the organic material include an organic pigment, an organic dye, fullerene, a polymer compound such as polydiacetylene and polyimide, and an aromatic hydrocarbon or an aliphatic hydrocarbon (e.g. an aromatic hydrocarbon or aliphatic hydrocarbon having orientation, or an aromatic hydrocarbon or aliphatic hydrocarbon having sublimation property). Of those, an organic pigment, an organic dye, or a polymer compound is preferable; and an organic pigment is particularly preferable. Further, two or more of them may be used in combination.

The organic pigment that can be used in the method of producing organic particles according to the present invention is not limited in the color tone thereof. Examples thereof include a perylene, perynone, quinacridone, quinacridonequinone, anthraquinone, anthanthrone, benzimidazolone, condensed disazo, disazo, azo, indanthrone, phthalocyanine, triaryl carbonium, dioxazine, aminoanthraquinone, diketopyrrolopyrrole, thioindigo, isoindoline, isoindolinone, pyranthrone or isoviolanthrone-compound pigment, or a mixture thereof.

More specifically, examples of the organic pigment include perylene-compound pigments, such as C.I. Pigment Red 190 (C.I. No. 71140), C.I. Pigment Red 224 (C.I. No. 71127), C.I. Pigment Violet 29 (C.I. No. 71129), or the like; perynone-compound pigments, such as C.I. Pigment Orange 43 (C.I. No. 71105), C.I. Pigment Red 194 (C.I. No. 71100) or the like; quinacridone-compound pigments, such as C.I. Pigment Violet 19 (C.I. No. 73900), C.I. Pigment Violet 42, C.I. Pigment Red 122 (C.I. No. 73915), C.I. Pigment Red 192, C.I. Pigment Red 202 (C.I. No. 73907), C.I. Pigment Red 207 (C.I. Nos. 73900, 73906), C.I. Pigment Red 209 (C.I. No. 73905) or the like; quinacridonequinone-compound pigments, such as C.I. Pigment Red 206 (C.I. No. 73900/73920), C.I. Pigment Orange 48 (C.I. No. 73900/73920), C.I. Pigment Orange 49 (C.I. No. 73900/73920), or the like; anthraquinone-compound pigments, such as C.I. Pigment Yellow 147 (C.I. No. 60645) or the like; anthanthrone-compound pigments, such as C.I. Pigment Red 168 (C.I. No. 59300) or the like; benzimidazolone-compound pigments, such as C.I. Pigment Brown 25 (C.I. No. 12510), C.I. Pigment Violet 32 (C.I. No. 12517), C.I. Pigment Yellow 180 (C.I. No. 21290), C.I. Pigment Yellow 181 (C.I. No. 11777), C.I. Pigment Orange 62 (C.I. No. 11775), C.I. Pigment Red 185 (C.I. No. 12516), or the like; condensed disazo-compound pigments, such as C.I. Pigment Yellow 93 (C.I. No. 20710), C.I. Pigment Yellow 94 (C.I. No. 20038), C.I. Pigment Yellow 95 (C.I. No. 20034), C.I. Pigment Yellow 128 (C.I. No. 20037), C.I. Pigment Yellow 166 (C.I. No. 20035), C.I. Pigment Orange 34 (C.I. No. 21115), C.I. Pigment Orange 13 (C.I. No. 21110), C.I. Pigment Orange 31 (C.I. No. 20050), C.I. Pigment Red 144 (C.I. No. 20735), C.I. Pigment Red 166 (C.I. No. 20730), C.I. Pigment Red 220 (C.I. No. 20055), C.I. Pigment Red 221 (C.I. No. 20065), C.I. Pigment Red 242 (C.I. No. 20067), C.I. Pigment Red 248, C.I. Pigment Red 262, C.I. Pigment Brown 23 (C.I. No. 20060), or the like; disazo-compound pigments, such as C.I. Pigment Yellow 13 (C.I. No. 21100), C.I. Pigment Yellow 83 (C.I. No. 21108), C.I. Pigment Yellow 188 (C.I. No. 21094), or the like; azo-compound pigments, such as C.I. Pigment Red 187 (C.I. No. 12486), C.I. Pigment Red 170 (C.I. No. 12475), C.I. Pigment Yellow 74 (C.I. No. 11714), C.I. Pigment Yellow 150 (C.I. No. 48545), C.I. Pigment Red 48 (C.I. No. 15865), C.I. Pigment Red 53 (C.I. No. 15585), C.I. Pigment Orange 64 (C.I. No. 12760), C.I. Pigment Red 247 (C.I. No. 15915), or the like; indanthrone-compound pigments, such as C.I. Pigment Blue 60 (C.I. No. 69800), or the like; phthalocyanine-compound pigments, such as C.I. Pigment Green 7 (C.I. No. 74260), C.I. Pigment Green 36 (C.I. No. 74265), Pigment Green 37 (C.I. No. 74255), Pigment Blue 16 (C.I. No. 74100), C.I. Pigment Blue 75 (C.I. No. 74160:2), 15 (C.I. No. 74160), or the like; triaryl carbonium-compound pigments, such as C.I. Pigment Blue 56 (C.I. No. 42800), C.I. Pigment Blue 61 (C.I. No. 42765:1), or the like; dioxazine-compound pigments, such as C.I. Pigment Violet 23 (C.I. No. 51319), C.I. Pigment Violet 37 (C.I. No. 51345), or the like; aminoanthraquinone-compound pigments, such as C.I. Pigment Red 177 (C.I. No. 65300), or the like; diketopyrrolopyrrole-compound pigments, such as C.I. Pigment Red 254 (C.I. No. 56110), C.I. Pigment Red 255 (C.I. No. 561050), C.I. Pigment Red 264, C.I. Pigment Red 272 (C.I. No. 561150), C.I. Pigment Orange 71, C.I. Pigment Orange 73, or the like; thioindigo-compound pigments, such as C.I. Pigment Red 88 (C.I. No. 73312), or the like; isoindoline-compound pigments, such as C.I. Pigment Yellow 139 (C.I. No. 56298), C.I. Pigment Orange 66 (C.I. No. 48210), or the like; isoindolinone-compound pigments, such as C.I. Pigment Yellow 109 (C.I. No. 56284), C.I. Pigment Orange 61 (C.I. No. 11295), or the like; pyranthrone-compound pigments, such as C.I. Pigment Orange 40 (C.I. No. 59700), C.I. Pigment Red 216 (C.I. No. 59710), or the like; or isoviolanthrone-compound pigments, such as C.I. Pigment Violet 31 (C.I. No. 60010), or the like.

Preferred organic pigments are quinacridone-compound pigments, diketopyrrolopyrrole-compound pigments, phthalocyanine-compound pigments, or azo-compound pigments. In the method of producing organic particles according to the present invention, a mixture of two or more organic pigments, a solid solution of organic pigments, or a combination thereof may also be used.

Examples of the organic dye that can be used in the method of producing organic particles according to the present invention include an azo dye, a cyanine dye, a merocyanine dye, and a coumarin dye. Examples of the polymer compound that can be used in the method of producing organic particles according to the present invention include polydiacetylene and polyimide.

Next, the method of forming organic particles will be described.

For the poor solvent for the organic material (which may hereinafter be referred to as “poor solvent for the organic material”, or may hereinafter be simply referred to as “poor solvent”), there is no particular limitation as long as the poor solvent is compatible, or mixes uniformly, with a good solvent to be described later. With respect to the poor solvent for the organic material, the solubility of the organic material in the poor solvent is preferably 0.02 mass % or less, more preferably 0.01 mass % or less. The solubility of the organic material in the poor solvent has no particular lower limit, but it is practical that the solubility is 0.000001 mass % or more in consideration of an organic material ordinarily used. The solubility may be solubility in the case where the organic material is dissolved in the presence of an acid or an alkali. Further, compatibility or uniform mixing property between the good solvent and the poor solvent is such that the solubility of the good solvent in the poor solvent is preferably 30 mass % or more, more preferably 50 mass % or more. The solubility of the good solvent in the poor solvent has no particular upper limit, but it is practical that the solvents can mix with each other at an arbitrary ratio.

Examples of the poor solvents include aqueous solvents (e.g., water, hydrochloric acid, and aqueous sodium hydroxide solution), alcohol compound solvents, ketone compound solvents, ether compound solvents, aromatic compound solvents, carbon disulfide solvents, aliphatic compound solvents, nitrile compound solvents, halogen-containing compound solvents, ester compound solvents, ionic solvents, and mixed solvents thereof. Preferable poor solvents include aqueous solvents, alcohol compound solvents, ketone compound solvents, ether compound solvents, ester compound solvents and mixed solvents thereof; and more preferable poor solvents include aqueous solvents, alcohol compound solvents and ester compound solvents.

Examples of the alcohol compound solvents include methanol, ethanol, isopropyl alcohol, n-propyl alcohol, 1-methoxy-2-propanol, and the like. Examples of the ketone compound solvents include acetone, methyl ethyl ketone, methyl isobutyl ketone, and the like. Examples of ether compound solvents include dimethylether, diethylether, tetrahydrofuran, and the like. Examples of the aromatic compound solvents include benzene, toluene, and the like. Examples of the aliphatic compound solvents include hexane, and the like. Examples of the nitrile compound solvents include acetonitrile, and the like. Examples of the halogen-containing compound solvents include dichloromethane, trichloroethylene, and the like. Examples of the ester compound solvents include ethyl acetate, ethyl lactate, 2-(1-methoxy)propyl acetate, and the like. Examples of the ionic solvents include a salt of 1-butyl-3-methylimidazolium and PF₆⁻, and the like.

The good solvent for dissolving the organic material will be described.

For the good solvent, there is no particular limitation as long as the good solvent can dissolve the organic material to be used, and is compatible, or uniformly mixed, with the poor solvent to be used at the time of the production of the organic particles. With respect to the solubility of the organic material in the good solvent, the solubility of the organic material is preferably 0.2 mass % or more, and more preferably 0.5 mass % or more. The solubility of the organic material in the good solvent has no particular upper limit, but it is practical that the solubility is 50 mass % or less in consideration of an organic material to be ordinarily used. The solubility may be solubility in the case where the organic material is dissolved in the presence of an acid or an alkali. A preferable range for compatibility or uniform mixing property between the poor solvent and the good solvent is as described above.

Examples of the good solvents include aqueous solvents (e.g., water, hydrochloric acid, and aqueous sodium hydroxide solution), alcohol compound solvents, amide compound solvents, ketone compound solvents, ether compound solvents, aromatic compound solvents, carbon disulfide, aliphatic compound solvents, nitrile compound solvents, sulfoxide compound solvents, halogen-containing compound solvents, ester compound solvents, ionic liquids, mixed solvents thereof, and the like. Among these, aqueous solvents, alcohol compound solvents, ketone compound solvents, ether compound solvents, sulfoxide compound solvents, ester compound solvents, amide compound solvents, and the mixed solvents thereof are preferable; aqueous solvents, alcohol compound solvents, ester compound solvents, sulfoxide compound solvents, and amide compound solvents are more preferable; aqueous solvents, sulfoxide compound solvents, and amide compounds solvents are further preferable; and amide compounds solvents are particularly preferable.

Examples of the sulfoxide compound solvent include dimethyl sulfoxide, diethyl sulfoxide, hexamethylene sulfoxide, and sulfolane. Examples of the amide compound solvent include N,N-dimethylformamide, 1-methyl-2-pyrrolidone, 2-pyrrolidinone, 1,3-dimethyl-2-imidazolidinone, 2-pyrroridinone, ε-caprolactam, formamide, N-methylformamide, acetamide, N-methylacetamide, N,N-dimethylacetamide, N-methylpropaneamide, and hexamethylphosphoric triamide.

Further, the concentration of the organic material solution prepared by dissolving the organic material in the good solvent is preferably in the range of from the saturation concentration of the organic material with respect to the good solvent under a condition at the time of the dissolution to about one hundredth of the saturation concentration. The concentration is preferably, for example, 0.5 to 12 mass %, though the preferable value varies depending on the organic material to be used.

The temperature sub-critical and supercritical conditions of a boiling point at normal pressure can be adopted for conditions under which the solution of the organic material is prepared. The temperature at which the solution is prepared under normal pressure is preferably −10 to 150° C., more preferably −5 to 130° C., and particularly preferably 0 to 100° C.

The above combination of the good solvent and the poor solvent can be appropriately selected and used, depending on the organic material to be used.

A preferred embodiment of the method of the present invention of producing organic particles comprises: mixing a poor solvent for an organic material with a solution of the organic material dissolved in a good solvent, thereby to form particles of the organic material in a resultant liquid mixture, said poor solvent being compatible with the good solvent, wherein the formation of the organic particles is conducted by any of the following processes a, b, and c [herein, the particles to be formed by the production method of the present invention may be crystalline particles, amorphous particles, or a mixture of these particles]:

[a] a process comprising: feeding the poor solvent and the solution of the organic material into a stirring vessel through predetermined numbers of liquid feed ports, respectively; mixing the poor solvent and the solution of the organic material under stirring in the stirring vessel, to form said organic particles; and taking out the liquid mixture containing the organic particles formed via the mixing under stirring;

[b] a process comprising: providing a stirring zone in part of a container filled with the poor solvent; feeding the solution of the organic material into the stirring zone; mixing the poor solvent with the solution of the organic material in the stirring zone under stirring, to form said organic particles; and making the organic particles flow out of the stirring zone into another zone of the container; and

[c] a process comprising: mixing the poor solvent with the solution of the organic material under the condition where a shearing force is applied.

Hereinafter, a mode based on the process a of the method of producing organic particles of the present invention will be described.

In the method of producing organic particles of the present invention based on the process a, the poor solvent and the solution of the organic material dissolved in the good solvent are fed into the stirring vessel through predetermined numbers of the liquid feed ports, respectively; and are stirred in the stirring vessel with stirring means. The temperature of the stirring vessel at the time of the preparation of the organic particles is preferably 0 to 100° C., and particularly preferably 5° C. to 80° C. The number of liquid feed ports for the solution of the organic material is preferably 1 to 5, and the number of liquid feed ports for the poor solvent is preferably 1 to 5. Providing predetermined numbers of feed ports as described above enables the production of organic particles composed of multiple kinds of organic materials.

In the method of producing organic particles of the present invention based on the process a, a pump can be used upon delivery of the solution of the organic material to the inside of the stirring vessel. The speed at which the solution of the organic material is added when the pump is used is preferably 0.1 to 500 ml/min, more preferably 1 to 400 ml/min, and particularly preferably 2 to 300 ml/min. The speed at which the poor solvent is added when the pump is used is preferably 10 to 5,000 ml/min, more preferably 10 to 4,000 ml/min, and particularly preferably 20 to 3,000 ml/min. A method of adding such solution or solvent when no pump is used is, for example, gravity drop.

The speed at which stirring is performed in the stirring vessel is preferably 100 to 15,000 rpm, more preferably 200 to 13,000 rpm, and particularly preferably 500 to 10,000 rpm. Further, stirring is preferably performed with a pair of stirring blades placed at two opposing sites distant from each other in the stirring vessel; it is more preferable that the stirring blades be rotated in directions opposite to each other, to control a state where the liquid is stirred in the stirring vessel. In this case, the respective stirring blades may be identical to or different from each other in stirring speed.

The speed at which the solution of the organic material is added and the speed at which the poor solvent is added may be different from or the same as each other, and such speeds can be controlled in relation to, for example, the concentration of the solution of the organic material and the speed at which the solution is stirred. Further, the poor solvent and the solution of the organic material are preferably added in a continuous manner. Further, when the organic particles are produced according to a continuous flow mode, a liquid is discharged while being fed. In this case, the speed at which the liquid is discharged is preferably 10 to 5,000 ml/min, more preferably 10 to 4,000 ml/min, and particularly preferably 20 to 3,000 ml/min.

A ratio of the addition flow rate of the solution of the organic material to the addition flow rate of the poor solvent (the solution of the organic material/the poor solvent) is preferably 1/50 to 2/3, more preferably 1/40 to 1/2, and particularly preferably 1/20 to 3/8 in volume ratio.

The concentration of the organic particle liquid after the preparation of the organic particles is not particularly restricted; the concentration of the particles is in the range of preferably 10 to 40,000 mg, more preferably 20 to 30,000 mg, and particularly preferably 50 to 25,000 mg, with respect to 1,000 ml of a dispersion solvent.

Next, a mode based on the process b of the method of producing organic particles of the present invention will be described.

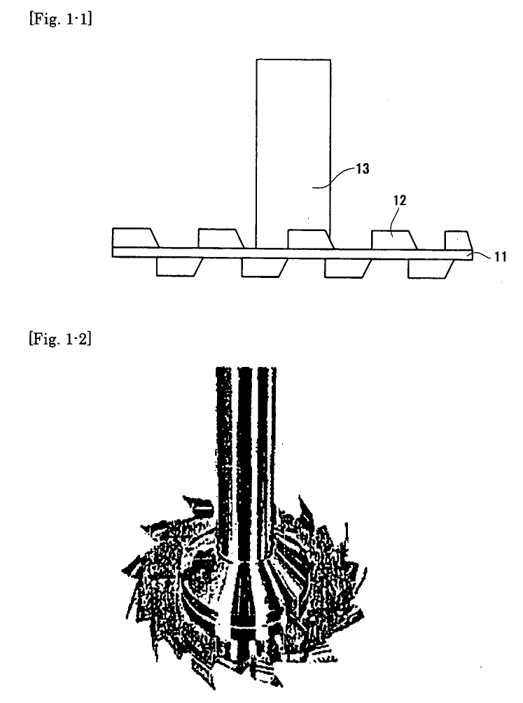

In the method of producing organic particles of the present invention based on the process b, the poor solvent is placed in the container, part of the container is defined as the stirring zone, and the stirring zone is also filled with the poor solvent (for example, a mode in which a mixing chamber is provided in the poor solvent, as shown in each of FIGS. 3-1 to 3-3 to be described later, can be given). The temperature of the poor solvent at the time of the preparation of the organic particles is preferably 0 to 100° C., or more preferably 5 to 80° C.

In the method of producing organic particles of the present invention based on the process b, a pump can be used upon delivery of the solution of the organic material to the inside of the mixing chamber provided in the container, or the pump may not be used. The speed at which the solution of the organic material is added when the pump is used is preferably 0.1 to 500 ml/min, more preferably 1 to 400 m/min, and particularly preferably 5 to 300 ml/min. A method of adding the solution when no pump is used is, for example, gravity drop.

The poor solvent is stirred with the stirring means; the speed at which the poor solvent is stirred is preferably 100 to 10,000 rpm, more preferably 150 to 8,000 rpm, and particularly preferably 200 to 6,000 rpm.

Further, in the method of producing organic particles of the present invention based on the process b, particles are formed by feeding the solution of the organic material into the stirring zone in the poor solvent. The solution of the organic material is preferably fed in a continuous manner, and the speed at which the solution is fed is preferably 0.1 to 500 ml/min, more preferably 1 to 400 ml/min, and particularly preferably 5 to 300 ml/min. When the solution is fed at an excessively high feeding speed, a particle having a large particle diameter may be mixed in with the desired particles. When the solution is fed at an excessively low feeding speed, a particle size distribution may widen. The speed at which the solution of the organic material is fed is preferably controlled in combination with, for example, the concentration of the solution of the organic material to be used or the speed at which the solution is stirred.

A ratio of the solution of the organic material to be added to the poor solvent to be added (the solution of the organic material/the poor solvent) is preferably 1/50 to 2/3, more preferably 1/40 to 1/2, and particularly preferably 1/20 to 3/8 in volume ratio.

The concentration of the organic particle liquid after the preparation of the organic particles is not particularly restricted; the concentration of the particles is in the range of preferably 10 to 40,000 mg, more preferably 20 to 30,000 mg, and particularly preferably 50 to 25,000 mg, with respect to 1,000 ml of a dispersion solvent.

The above combination of the good solvent and the poor solvent can be appropriately selected and used depending on the organic material to be used.

Next, a mode based on the process c of the method of producing organic particles of the present invention will be described.

In the mode, the solution of the organic material dissolved in the good solvent, and the poor solvent for the organic material, which poor solvent is compatible with the good solvent, are mixed in the stirring vessel. The temperature of the stirring vessel at the time of the preparation of the organic particles is preferably 0 to 100° C., and particularly preferably 5° C. to 80° C.

For a method of adding the solution of the organic material to the poor solvent, there is no particular limitation, as long as a shearing force is applied to the organic material solution to be added, and a pump or the like can be used. Further, the solution may be added from the inside of the poor solvent, or may be added from the outside of the poor solvent; the solution is more preferably added from the inside of the poor solvent.

The speed at which stirring is performed in the stirring vessel is preferably 100 to 10,000 rpm, more preferably 200 to 8,000 rpm, and particularly preferably 300 to 6,000 rpm.

A ratio of the solution of the organic material to be added to the poor solvent to be added (the solution of the organic material/the poor solvent) is preferably 1/50 to 2/3, more preferably 1/40 to 1/2, and particularly preferably 1/20 to 3/8 in volume ratio.

The concentration of the organic particle liquid after the preparation of the organic particles is not particularly restricted; the concentration of the particles is in the range of preferably 10 to 140,000 mg, more preferably 20 to 730,000 mg, and particularly preferably 50 to 25,000 mg, with respect to 1,000 ml of a dispersion solvent.

Herein, the “shearing force” as used in the present invention refers to a shear force (shear stress) to be exerted by a stirring blade on a droplet produced after the mixing of the solution of the organic material into the poor solvent. Also herein, the “under the condition where a shearing force is applied” as used in the present invention refers to a state where forces opposite to each other in a given direction act in the respective arbitrary parallel plane(s) in a droplet. Examples of a format in which a droplet deforms under the condition where a shearing force is applied include: a format in which a spherical liquid becomes a prolate spheroid, further becomes a long cylindrical thread or a flat plate, and is destroyed to be small particles; and a format in which a spherical liquid becomes a prolate spheroid, a constriction appears at the center of the spheroid, and the constriction portion disrupts to provide small particles.

In the method of producing organic particles of the present invention based on the process c, a stirring portion (a stirrer) is preferably used in order that a shearing force may be applied to the solution of the organic material. The shape of the stirring portion is not particularly limited as long as the portion is of such a shape that the portion can apply a desired shearing force. General examples of the stirring portion include a paddle blade, a turbine blade, a screw blade, a Pfaudler blade, a dissolver blade, and a stirrer provided with a turbine (portion) capable of rotating and an immobilized stator (portion). Preferable examples of the stirring portion include a dissolver blade, and a stirrer constituted of a turbine portion capable of rotating and an immobilized stator portion placed around the turbine portion with a slight gap between the portions.

A dissolver blade is a special stirring blade having a function of applying a shearing force. The shape of the dissolver blade is not particularly limited as long as the blade is of such a shape that the blade can apply a shearing force; a preferable shape is such that multiple blades are alternately formed at an upper and lower portions of the notched circumferential portion of a disk portion so that an angle formed between the disk portion and each blade is in the range of from 10° to 170°. The shape of each blade is not particularly limited; examples of the shape include a rectangle, a trapezoid, and a triangle, and each blade may have a gap (void).

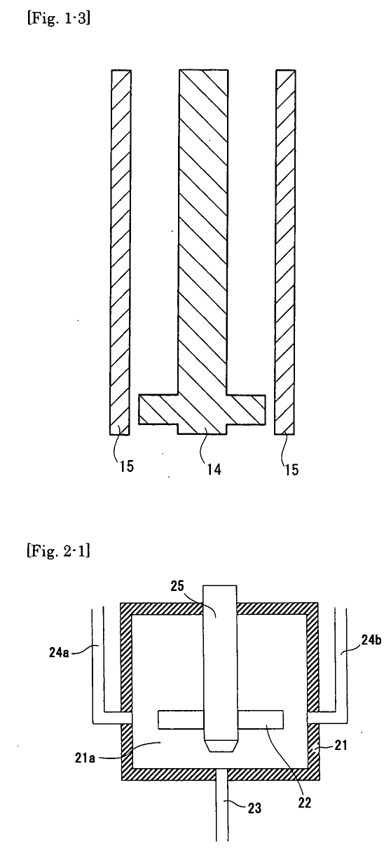

FIG. 1-1 is a front view schematically showing an example of a dissolver blade that can be used in the present invention. Trapezoidal blades 12 are alternately placed at a certain interval at on and under a disk portion 11, and the center of the disk portion 11 is provided with a shaft 13. The radius of each blade is not particularly limited; for example, in the case where stirring is performed in a cylindrical container, the radius is preferably 1/5 to 4/5, or more preferably 1/4 to 1/2.8 of the radius of the container. FIG. 1-2 is a photograph, as an alternative to a figure, showing an example of such dissolver blade that can be used in the method of producing organic particles of the present invention as described above.

In the present invention, it is also preferable to perform the mixing under the condition where a shearing force is applied, with a dissolver stirring machine, or with a stirring machine, emulsifier, or dispersing machine provided with a stirrer constituted of a turbine portion capable of rotating and an immobilized stator portion placed around the turbine portion with a slight gap between the portions.

FIG. 1-3 is a sectional view schematically showing the stirring portion (the stirrer) constituted of the turbine (portion) capable of rotating and the immobilized stator (portion) placed around the turbine with a slight gap between the turbine and the stator. The stirring portion is composed of a turbine portion 14 capable of rotating and an immobilized stator portion 15. The size of an interval between the turbine portion 14 and the stator portion 15, which is not particularly limited, is preferably 0.1 mm to 10 mm, and particularly preferably 0.3 mm to 5 mm. Examples of a usable stirring machine, emulsifier, or dispersing machine provided with a stirrer constituted of a turbine portion capable of rotating and an immobilized stator portion placed around the turbine portion with a slight gap between the portions, include Physcotron manufactured by Microtec Co., Ltd., T.K Homomixer manufactured by Tokushu Kika Co., Ltd, and ULTRA-TURRAX manufactured by IKA.

In the method of producing organic particles of the present invention based on the process c, the use of such stirring means enables the production of excellent organic particles in a reprecipitation method (involving change from a liquid-liquid mixture to a solid-liquid mixture), unlike a reduction in size of an emulsified particle in an emulsion (liquid-liquid mixture) or a reduction in size of a bulk particle in a dispersion product (a solid-liquid mixture).

In the method of producing organic particles of the present invention based on the process c, the stirring speed can be set, according to the viscosity of the poor solvent, a temperature, and the kind and addition amount of a surfactant, and it is preferably 100 to 10,000 rpm, more preferably 150 to 8,000 rpm, and particularly preferably 200 to 6,000 rpm. The number of revolutions in the range enables preferable stirring without the involvement of air bubbles in the poor solvent.

A dispersant may be used in the method of producing organic particles of the present invention. For example, an anionic dispersant, a cationic dispersant, an amphoteric dispersant, or a nonionic dispersant can be added. Such dispersant may be added to the pigment solution, may be added to the poor solvent, or may be added to both of them. Further, such dispersant may be added after the production of the organic particles.

As to an average particle diameter of particles, an average scale of a group can be represented by digitalizing by several measurement methods. There are frequently-used parameters, such as mode diameter indicating the maximum value of distribution, median diameter corresponding to the median value in the integral frequency distribution curve, and various average diameters (number-averaged, length-averaged, area-averaged, weight-averaged diameters, volume-averaged diameters, or the like), and the like. In the present invention, the average particle diameter means a number-averaged diameter, unless otherwise specified. The average particle diameter of organic particles (primary particles) which are contained in an organic particle liquid mixture to be produced by the method of producing organic particles of the present invention, is preferably 500 μm or less, more preferably 100 μm or less, and particularly preferably 10 μm or less. Further, in case of preparing nano-meter-size nano-particles, the particle diameter thereof is preferably 1 nm to 1 μm, more preferably 1 to 200 nm, further preferably 2 to 100 nm, and particularly preferably 5 to 80 nm.

Further, unless otherwise specified, a ratio (Mv/Mn) of a volume average particle diameter (Mv) to a number average particle diameter (Mn) is used as an index representing the uniformity of particle sizes (a state where particles are monodisperse and have a uniform size) in the present invention. The monodispersity of organic particles (primary particles) which are contained in the organic particle liquid mixture to be produced by the method of producing organic particles of the present invention (the “monodispersity” as used in the present invention refers to the degree to which particle diameters are uniform), i.e. the ratio Mv/Mn, is preferably 1.0 to 2.0, more preferably 1.0 to 1.8, and particularly preferably 1.0 to 1.5.

Examples of a method of measuring the particle diameter of the organic particle include a microscopic method, a gravimetric method, a light scattering method, a light shielding method, an electric resistance method, an acoustic method, and a dynamic light scattering method. Of these, the microscopic method and the dynamic light scattering method are particularly preferable. Examples of a microscope to be used in the microscopic method include a scanning electron microscope and a transmission electron microscope. Examples of a particle measuring device according to the dynamic light scattering method include Nanotrac UPA-EX 150 manufactured by NIKKISO Co., Ltd., and a dynamic light scattering photometer DLS-7000 series manufactured by OTSUKA ELECTRONICS CO., LTD.

In the case where monodisperse organic particles each having a desired particle diameter are obtained in this way, when, for example, an organic pigment is used, ink-jet ink which is excellent in light. fastness and water resistance and permeates well into paper can be obtained as described above, and a reduction in thickness of a color filter can be realized when the organic particles are used in the color filter. Further, when a substance excellent in electrical insulating property, such as polyimide, is used, larger electrical insulating property can be expected from a reduction in size of the particles.

Next, a production apparatus that can be used in the method of producing organic particles of the present invention will be described.

A preferred embodiment of the apparatus of producing organic particles of the present invention is one, in which a solution of an organic material dissolved in a good solvent is mixed with a poor solvent for the organic material, thereby to form particles of the organic material in a resultant liquid mixture, said poor solvent being compatible with the good solvent, and in which the apparatus has any of the following means A and B:

[A] means which comprises: predetermined numbers of liquid feed ports through which the poor solvent and the solution of the organic material dissolved in the good solvent are made to flow, respectively; a liquid discharge port for discharging a liquid that has been subjected to the stirring; and stirring means; and

[B] means which comprises: a container capable of containing the poor solvent; a mixing chamber which is provided in the container and the inside of which is capable of being filled with the poor solvent; and stirring means for mixing and stirring the poor solvent and the solution of the organic material fed into the mixing chamber, the stirring means being provided in the mixing chamber.

Hereinafter, a mode in which the apparatus of producing organic particles of the present invention has the means A will be described.

The apparatus of producing organic particles according to the mode can be used in the production method of the present invention including the process a described above, and is an apparatus for stirring the liquid mixture of the poor solvent and the solution of the organic material with the stirring means. Of such apparatuses, a preferable apparatus is such that the stirring means is a pair of stirring blades placed at two opposing sites distant from each other in a stirring vessel, and the stirring blades are rotated in directions opposite to each other, to control a state of stirring. Further, it is preferable that: an external magnet be placed on the outside of the wall of the stirring vessel close to the respective stirring blade; the external magnet and the respective stirring blade form a magnetic coupling having no penetrating axis; and the respective stirring blade be rotated by rotating the external magnet.

Hereinafter, the production apparatus having the means A as a preferred embodiment of the present invention will be described with reference to the figures, but the present invention should not be construed as being limitative by the following description.

FIG. 2-1 is a sectional view schematically showing an embodiment of the production apparatus having the means A. FIG. 2-1 shows a stirring vessel external wall 21, with a vertical section at a position penetrating through a shaft coupled with a stirring blade 22. In FIG. 2-1, the poor solvent and the solution of the organic material are, preferably continuously, fed and made to flow in a stirring vessel 11a through two liquid feed ports with feed pipes 24a and 24b, respectively. The size of the stirring vessel is not particularly limited. Stirring is performed in the stirring vessel 21a with the stirring blade 22. An organic particle liquid mixture produced after the completion of stirring is preferably immediately drawn out of a discharge port through a discharge pipe 23, in order that giant particles can be prevented from being formed, specifically, organic particles formed in the stirring vessel 21a may be prevented from remaining in the stirring vessel 21a to: be bonded to other organic particles to become larger particles; or be exposed to the solution of the organic material fed from the feed pipe 24a or 24b to become larger particles.

FIG. 2-2 is an apparatus explanatory view schematically showing another embodiment of the production apparatus having the means A. As shown in FIG. 2-2, a stirring device (stirrer) 210 have: a cylindrical stirring vessel 218 provided with two liquid feed ports 212 and 213 into which the solution of the organic material and the poor solvent are made to flow, respectively, and a liquid discharge port 216 for discharging a mixed liquid that has been subjected to stirring; and a pair of stirring blades 221 and 222 as stirring means for controlling a state where a liquid is stirred in the stirring vessel 218 by being rotated in the stirring vessel 218.

The stirring vessel 218 is constituted of: a cylindrical vessel main body 219 with its central axis directed in a vertical direction; and sealing plates 220 as vessel walls for capping the upper and lower opening ends of the vessel main body 219. Further, each of the stirring vessel 218 and the vessel main body 219 is formed of a non-magnetic material excellent in magnetic permeability. The two liquid feed ports 212 and 213 are provided at positions close to the lower end of the vessel main body 219, and the liquid discharge port 216 is provided at a position close to the upper end of the vessel main body 219. Providing the discharge port at a position close to the upper end as described above can prevent the discharge of a mixed liquid that has been insufficiently subjected to stirring.

Further, the pair of stirring blades 221 and 222 is placed at upper and lower opposing ends in the stirring vessel 218 to be distant from each other, and are rotated in directions opposite to each other. The respective stirring blade 221 and 222 constitutes a magnetic coupling C together with an external magnet 226 placed on the outside of the vessel wall (sealing plate 220) close to the respective stirring blade 221 and 222. That is, the respective stirring blade 221 and 222 is coupled with the corresponding external magnet 226 by a magnetic force, and the blades are rotated in directions opposite to each other, by rotating the respective external magnets 226 with independent motors 228 and 229.

As indicated by a broken line arrow (X) and a solid line arrow (Y) in FIG. 2-2, the pair of stirring blades 221 and 222 placed in the vessel 218 to be opposed to each other forms stirring flows different from each other in direction in the vessel 218. Since the stirring flows formed by the respective stirring blades 221 and 222 are different from each other in flow direction, the flows collide with each other, to produce, in the vessel 218, high-speed turbulence that accelerates stirring in the vessel 218. The turbulence can: prevent a flow in the vessel 218 from being brought into a steady state; and inhibit the formation of cavities around the rotation axes of the stirring blades 221 and 222 even when the rotational speed of each of the stirring blades 221 and 222 is increased. At the same time, the turbulence can inhibit the occurrence of an inconvenience, in other words, the formation of a steady flow flowing in the stirring vessel 218 along the inner peripheral surface of the stirring vessel 218 without receiving a sufficient stirring action. Therefore, an increase in rotational speed of each of the stirring blades 221 and 222 can easily increase the processing speed. Further, at that time, the increase in rotational speed can inhibit the discharge of a liquid that has been insufficiently stirred and mixed owing to the fact that a liquid flow in the vessel 218 is brought into a steady state, thereby a deterioration in processing quality can be prevented.

Further, the respective stirring blades 221 and 222 in the stirring vessel 218 are coupled with the motors 228 and 229 placed outside the stirring vessel 218 by the magnetic couplings C. As a result, there is no need for inserting a rotation axis into each vessel wall of the stirring vessel 218, so the stirring vessel 218 can take a closed container structure free of a portion (a cavity) through which a rotation axis is inserted. Thus, it is possible to prevent leakage of a stirred and mixed liquid to the outside of the vessel from being occurred, and, at the same time, it is possible to prevent deterioration in processing quality due to contamination, for example, of a lubricating liquid for a rotation axis (a sealing liquid) as an impurity contaminated into the liquid in the vessel 218 from being occurred.

According to the apparatus of producing organic particles of the present invention having the means A, the use of the above-mentioned production apparatus can attain the production of organic particles, according to a batch mode or a continuous flow mode. Production to be conducted according to the continuous flow mode is preferable because of its advantage to mass production. In this case, use can be made of apparatuses each having a construction as shown in FIGS. 2-1 and 2-2, respectively. Of the apparatuses, the apparatus having construction as shown in FIG. 2-2 is preferably used.

Further, the apparatus of producing organic particles of the present invention having the means A can keep a ratio between the organic material solution and the poor solvent liquid fed into the stirring vessel constant at all times, since the thus-produced organic particle dispersion liquid is quickly or immediately discharged out. Thus, the solubility of the organic material in the dispersion liquid can be kept constant during a time period commencing on the initiation of the production of the organic particles and ending on the completion of the production, so monodisperse organic particles can be stably produced.

Further, monodisperse organic particles can be produced further stably, by inhibiting the discharge of an organic particle liquid mixture that has been insufficiently stirred and mixed owing to the fact that a liquid flow in the vessel be brought into a steady state, and by preventing contamination, for example, of a lubricating liquid (a sealing liquid) for a rotation axis as an impurity contaminated into a liquid in the vessel from being occurred.

Hereinafter, a mode of the apparatus of producing organic particles of the present invention having the means B will be described.

The production apparatus according to the mode can be used in the production method of the present invention including the process b described above, and is an apparatus that performs stirring in the mixing chamber with the stirring means. Further, the apparatus is preferably such that the poor solvent and the good solvent are quickly/immediately mixed in the mixing chamber with the first stirring means, and organic particles formed are immediately discharged to the outside of the mixing chamber with the second stirring means. Stirring means and a mixing chamber to be described later can be preferably used as the stirring means and the mixing chamber.

Hereinafter, several embodiments of the production apparatus based on the means B will be described with reference to the figure, but the present invention should not be construed as being limitative by the following description.

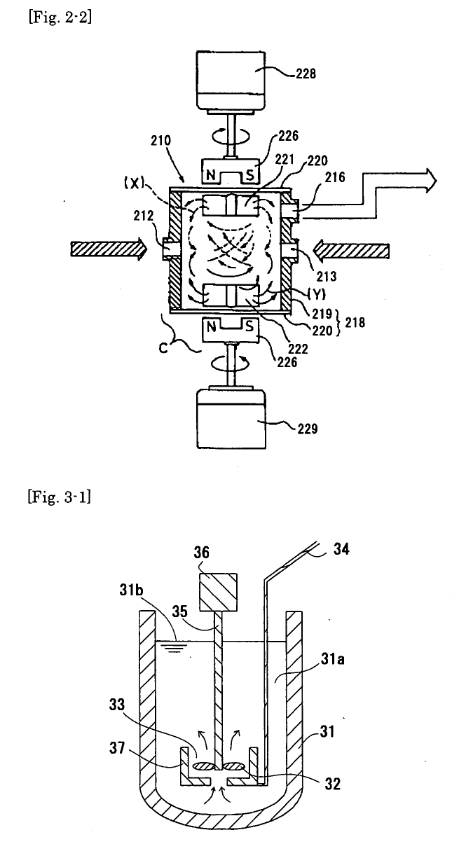

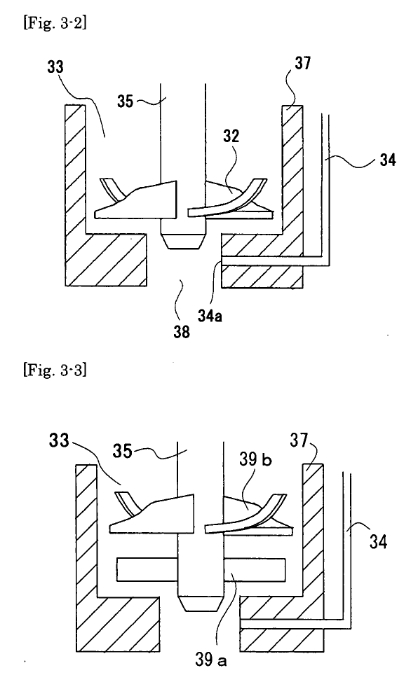

FIG. 3-1 is a sectional view schematically showing an embodiment of the production apparatus having the means B. In FIG. 3-1, the solution of the organic material is fed, preferably in a continuous manner, through a feed pipe 34 into a mixing chamber (stirring zone) 33 provided for a liquid vessel 31a in a container 31. Herein, a poor solvent is contained in the container 31, and the mixing chamber 33 is provided below a liquid surface 31b of the poor solvent. The inside of the mixing chamber is also filled with the poor solvent. The size of the mixing chamber is preferably one fifth or less, more preferably one tenth or less, or still more preferably one fifteenth or less of the size of the container in volume ratio.

Further, it is preferable that a bulk poor solvent in the reaction container 31 be made to flow in a convective manner upward (in the direction indicated by an arrow of FIG. 3-1) in the mixing chamber 33 at all times by the action of the mixing chamber 33. Further, the inside of the mixing chamber 31 is provided with a stirring blade 32 coupled with a shaft 35, and the blade is rotated by a motor 36. For materials to form the container 31, the stirring blade 32, the mixing chamber 33, the feed pipe 34, the shaft 35, and the motor 36, there is no particular limitation, and a material used in an ordinary stirring device can be appropriately selected and used for each of the components.

FIG. 3-2 is a partially enlarged sectional view showing the mixing chamber 33, with a partial cross-section thereof, as a preferred embodiment of the apparatus of FIG. 3-1. The solution of the organic material is fed through the feed pipe 34 into the mixing chamber 33. The size of an opening portion 34a is preferably 1 cm or less, more preferably 0.8 cm or less, or still more preferably 0.5 cm or less. The opening portion 34a is preferably positioned below the stirring portion of the mixing chamber. Further, the number of feed pipes 34 or opening portions 34a to be provided may be two or more in order that the solution may be added within a short time period. In this embodiment, the mixing chamber 33 is formed of a casing 37 composed of a right-angled square tube having a constant sectional area. The upper end of the casing 37 is an open end (open portion), and the lower end of the casing is provided with a hole 38 so that the poor solvent in the mixing chamber 33 is in communication with the bulk poor solvent outside the stirring zone (in the construction shown in the figure, a zone of the poor solvent 31a except the mixing chamber 33 corresponds to a zone outside the stirring zone, and is also referred to as “external stirring zone”). The shape of the hole 38 is not particularly limited, and examples of the shape include a circular shape and a rectangular shape. Multiple holes may be provided for the lower end. In this embodiment, the organic material solution feed pipe 34 is provided in a wall of which the lower end of the casing 37 is constituted, and is opened toward the hole 38. It should be noted that the figure is a vertical sectional view showing the casing 37 at the position where the feed pipe is provided. Further, the inside of the mixing chamber 33 is provided with the stirring blade 32 which is attached to the shaft 35 and which is rotated by a motor (not shown). The rotation of the blade 32 causes the poor solvent to circulate upward in the mixing chamber 33 through a circular hole at all times.

The stirring blade 32 provided in the above mixing chamber 33 must generate desired mixing strength in the mixing chamber. The mixing strength is presumed to be an important operation factor to the size of a droplet upon mixing of the solution of the organic material.

Further it is preferable to properly select the stirring blade 32 having an ability to draw out the organic particles to be formed in a mixing space quickly/immediately to discharge the organic particles to the outside of the mixing chamber 33 quickly/immediately, in order that giant particles may be prevented from being formed, specifically, the formed organic particles may be prevented from remaining in the mixing chamber 33 to: be bonded to other organic particles to become larger particles; or be exposed to the solution of the organic material fed into the mixing chamber 33 to become larger particles.

The stirring blade 32 may be of any type, and, for example, any of a turbine type and a fan turbine type can be used.

Further, as described above, the casing 37 in this embodiment is constituted of a square tube. Thus, a flow produced by the stirring blade 32 is disturbed by a corner of the casing 37, whereby a mixing effect can be further enhanced, without the need for an additional member such as a baffle plate.

FIG. 3-3 is a partially enlarged sectional view showing the mixing chamber 33, with a partial cross-section thereof, as another embodiment of the apparatus of FIG. 3-1. In this embodiment, two stirring blades (a stirring blade 39a for mixing and a stirring blade 39b for discharging) are provided so that the apparatus has a first stirring means for quickly/immediately mixing the poor solvent and the good solvent, and a second stirring means for immediately discharging the thus-formed organic particles to the outside of the mixing chamber. Other components, such as the casing 37 and the feed pipe 34, are the same as those described for the apparatus of FIG. 3-2.

By providing two stirring blades as described above, it is possible to independently select an ability to control mixing strength and an ability to discharge the thus-formed organic particles to the outside of the mixing chamber, thereby such an operation can be performed that the mixing strength and the amount of a circulating solvent each are independently set to a desired value.

Next, a method of concentrating the organic particle liquid mixture will be described.

By concentrating the organic particle liquid mixture produced by the above-mentioned production method and/or production apparatus, it is possible to produce, on an industrial scale, a dispersed organic particle liquid favorable for a color filter coating liquid or for ink-jet ink. The concentration method is not particularly restricted as long as the organic particle liquid can be concentrated, and examples of the method include: (i) a method involving adding and mixing an extraction solvent to the organic particle liquid mixture, concentrating and extracting organic particles in the extraction solvent phase, and filtrating the concentrated extract liquid through a filter or the like, thereby to prepare a target concentrated extract liquid; (ii) a method involving sedimenting organic particles by centrifugal separation, and concentrating the liquid; (iii) a method involving drying a solvent under heat or reduced pressure, to concentrate the liquid; and a combination of these methods. The concentration of the organic particle liquid after concentration is preferably 1 to 100 mass %, more preferably 5 to 100 mass %, and particularly preferably 10 to 100 mass %.

The extraction solvent that can be used in the concentration extraction is not particularly limited; and a preferable extraction solvent is one which is substantially incompatible (immiscible) with the dispersion solvent (e.g. an aqueous solvent) of the organic particle dispersion liquid, and which forms an interface when the solvent is left standing after the mixing. (The “substantially incompatible (immiscible) with” as used in the present invention refers to a state where compatibility between the solvents is low, and the amount of the extraction solvent to be dissolved in the dispersion solvent is preferably 50 mass % or less, and more preferably 30 mass % or less. Although the amount of the extraction solvent to be dissolved in the dispersion solvent has no particular lower limit, it is practical that the amount is I mass % or more in consideration of the compatibility of an ordinary solvent.) Further, the extraction solvent is preferably a solvent that causes weak aggregation to such a degree that the organic particles can be redispersed in the extraction solvent. In the present invention, ‘weak, redispersible aggregation’ means that aggregates can be redispersed without applying a high shearing force such as by milling or high-speed agitation. Such a state is preferable, because it is possible to prevent strong aggregation that may change the particle size and to swell the organic particles with the extraction solvent, besides the dispersion solvent such as water can be easily removed by filter filtration. As the extraction solvents, any of ester compound solvents, alcohol compound solvents, aromatic compound solvents, and aliphatic compound solvents are preferable; ester compound solvents, aromatic compound solvents, and aliphatic compound solvents are more preferable; ester compound solvents are particularly preferable. Examples of the ester compound solvents include 2-(1-methoxy)propyl acetate, ethyl acetate, ethyl lactate, and the like. Examples of the alcohol compound solvents include n-butanol, isobutanol, and the like. Examples of the aromatic compound solvents include benzene, toluene, xylene, and the like. Examples of the aliphatic compound solvents include n-hexane, cyclohexane, and the like. Furthermore, the extraction solvent may be a pure solvent of one of the preferable solvents above, or alternatively it may be a mixed solvent composed of plurality of the solvents.

An amount of the extraction solvent is not particularly limited, as long as the solvent can extract the organic particles, but the amount of the extraction solvent is preferably smaller than an amount of the organic particle dispersion liquid, taking extraction for concentration into consideration. When expressed by volume ratio, the amount of the extraction solvent to be added is preferably in the range of 1 to 100, more preferably in the range of 10 to 90, and particularly preferably in the range of 20 to 80, with respect to 100 of the organic particle dispersion liquid. A too-large amount may results in prolongation of the time period for concentration, while a too-small amount may cause insufficient extraction and residual particles in the dispersion solvent.

After addition of the extraction solvent, the resultant mixture is preferably stirred and mixed well for sufficient mutual contact with the organic particle liquid. Any usual method may be used for stirring and mixing. The temperature at the time of addition and mixing of the extraction solvent is not particularly limited, but it is preferably 1 to 100° C. and more preferably 5 to 60° C. Any apparatus may be used for addition and mixing of the extraction solvent as long as it can favorably carry out each step. For example, a separatory funnel-like apparatus may be used.

As described above, examples of a method of concentrating an organic particle liquid mixture include (i) a filter filtration method, (ii) a centrifugal separation method, and (iii) a method involving drying under reduced pressure. In the method of producing organic particles of the present invention, use may be made of at least one method selected from (ii) the centrifugal separation method and (iii) the method involving drying under heat and reduced pressure.

(i) First, the filter filtration method will be described.

As an apparatus for filter filtration, use can be made, for example, of a high-pressure filtration apparatus. Preferable examples of the filter to be used include nanofilter, ultrafilter, and the like. It is preferable to remove a residual dispersion solvent by filter filtration, to further concentrate organic particles in the thus-concentrated extract liquid and to obtain a concentrated particle liquid.

A concentration method that is a combination of concentration extraction and filter filtration, enables the efficient concentration of organic particles from an organic particle dispersion liquid. As for the concentration ratio via the filter filtration, it is possible, for example, to raise the concentration of organic particles in an organic particle liquid mixture after concentrating preferably 100 to 1,000 times, more preferably 500 to 1,000 times the original concentration. Further, according to the method, it is possible to realize a high extraction rate, by almost eliminating residual organic particles in the residual mixed solvent after extraction of the organic particles.

(ii) Next, the centrifugal separation method will be explained.

A centrifugal separator to be used may be any device as long as the device can sediment organic particles in an organic particle dispersion liquid or in an organic particle concentrated extract liquid. Examples of the centrifugal separator include a usual device, a system having a skimming function (function with which a supernatant layer is sucked during the rotation of the system, to discharge to the outside of the system), and a continuous centrifugal separator for continuously discharging solid matter.

As the conditions for centrifugal separation, the centrifugal force (a value representing a ratio of an applied centrifugal acceleration to the gravitational acceleration) is preferably 50 to 10,000, more preferably 100 to 8,000, and particularly preferably 150 to 6,000. The temperature at the time of centrifugal separation is preferably −10 to 80° C., more preferably −5 to 70° C., and particularly preferably 0 to 60° C., though a preferable temperature varies depending on the kind of the solvent of the dispersion liquid. The mass of the organic material in a supernatant after concentration by the centrifugal separation is preferably 15 or less, or more preferably 10 or less, when the mass of the organic material in a liquid mixture or in an extract before the centrifugal separation is defined to as 100. Further, the organic material concentration in paste-like solid matter to be sedimented by the centrifugal separation is preferably 1 to 60%, or more preferably 2 to 50%.

(iii) Further, the method of drying under heat and reduced pressure will be described.

For a device for use in the concentration of the organic particles by drying under heat and reduced pressure, there is no particular limitation as long as the solvent of the organic particle dispersion liquid or the organic particle concentrated extract (extracted liquid) can be evaporated. Examples of the device include a usual vacuum drier and a usual rotary pump, a device capable of drying a liquid under heat and reduced pressure while stirring the liquid, and a device capable of continuously drying a liquid by passing the liquid through a tube the inside of which is heated and reduced in pressure.

The temperature for drying under heat and reduced pressure is preferably 30 to 230° C., more preferably 35 to 200° C., and particularly preferably 40 to 180° C. The pressure for the above-mentioned reduced pressure is preferably 100 to 100,000 Pa, more preferably 300 to 90,000 Pa, and particularly preferably 500 to 80,000 Pa. The organic pigment concentration in paste-like solid matter after the drying under heat and reduced pressure is preferably 10 to 80%, or more preferably 15 to 75% in mass ratio.

According to the method of producing organic particles of the present invention, even when the particles cause aggregation owing to the concentrating thereof, the resultant particles can be finely dispersed into primary particles by redispersion due to, for example, irradiation with an ultrasonic wave. The particle diameter of each of the particles can be preferably 1 to 200 nm, more preferably 2 to 100 nm, and particularly preferably 5 to 80 nm. Further, the ratio Mv/Mn of the particles after the redispersion can be preferably 1.0 to 2.0, more preferably 1.0 to 1.8, and particularly preferably 1.0 to 1.5.

When showing the redispersibility of the particles on the basis of an average particle diameter of the aggregate of the organic particles (the particle diameter may hereinafter be referred to as “aggregated particle diameter”) and an average particle diameter of the primary particles in the aggregate (the particle diameter may hereinafter be referred to as “primary particle diameter”); and the redispersibility can be evaluated by using a value that is obtained by dividing the aggregated particle diameter by the primary particle diameter (the thus-obtained value may hereinafter be referred to as “redispersion index”).

According to the method of producing organic particles of the present invention, the redispersion index of the organic particles in the resultant concentrated liquid can be made to preferably 1.0 to 2.0, or more preferably 1.0 to 1.9. The redispersion index represents the extent to which. particles aggregate; and as the particles are dispersed to have a particle diameter close to the primary particle diameter, a value of the redispersion index is reduced to be close to 1.

According to the method of producing organic particles of the present invention, it is possible to efficiently concentrate the organic particles from an organic particle dispersion liquid. With regard to the concentration ratio, for example, when the density of particles in an organic particle dispersion liquid as a raw material is defined as 1, the density in the concentrated organic particle paste can be concentrated to a magnification of preferably about 100 to 3,000, or more preferably about 500 to 2,000.

According to the method of producing organic particles of the present invention and/or the production apparatus that can be used in the method of the present invention, organic particles can be produced on an industrial scale, in which the temperature dependency of particle size of the organic particles around room temperature is small and the organic particles are favorable for a color filter coating liquid or for ink-jet ink.

Further, according to the method of producing organic particles of the present invention, it is possible to efficiently concentrate the organic particles, by removing the solvent from an organic particle dispersion liquid that has been produced by the reprecipitation method. Even upon increase in amount of a good solvent to be added into a poor solvent at the time of course of the production of the organic particles by the reprecipitation method, or increase in production scale of said organic particles, the particles can be concentrated while neither an increase in its particle size nor the deterioration of its monodispersity substantially occurs. Further, the organic particles aggregated by the concentrating can be easily redispersed, thereby enabling the highly efficient production of the organic particles. According to the method of producing organic particles of the present invention, organic particles having a desired particle size can be concentrated, even when the particle size is a fine-particle diameter of a nanometer size (for example, 10 to 100 nm). Thus, when the organic particles are used for inkjet ink, the ink has a high optical density, is excellent in uniformity of a surface of a resultant image, has high chroma, and is vivid. Further, when the organic particles are used for a color filter, the color filter has a high optical density, is excellent in uniformity of its surface, has high contrast, and can reduce the noise of a resultant image.

The present invention will be described in more detail based on the following examples, but the invention is not limited thereto.

### EXAMPLES

### Example 1-1

A 15-mmol/L pigment solution was prepared by dissolving a pigment (Pigment Red 254) in a solution prepared by mixing 1-methyl-2-pyrrolidone and a 1-mol/L aqueous sodium hydroxide solution at a ratio of 6:1. Water was separately provided as a poor solvent. A stirring device, as shown in FIG. 2-2 (the stirring vessel of which had a volume of 8.3 cc), was used. The temperature of the stirring vessel was controlled to 1° C., 15C, 25° C., or 35° C. A pair of stirring blades was rotated in directions opposite to each other at 2,000 rpm. The pigment solution was added from one feed port of the stirring vessel to the stirring vessel at a flow rate of 10 ml/min, the poor solvent was added from another feed port of the stirring vessel to the stirring vessel at a flow rate of 100 ml/min, and 1,000 ml of an organic pigment particle dispersion liquid taken out of a discharge port was collected. Dispersion liquids obtained at the respective temperatures are designated to as Sample Pigment Liquids (101) to (104).

### Example 1-2

A 150-mmol/L pigment solution was prepared by dissolving a pigment (Pigment Red 254) in a solution prepared by mixing dimethylsulfoxide and a 8-mol/L aqueous sodium hydroxide solution at a ratio of 6:1. Water was separately provided as a poor solvent. The stirring device, as that of Example 1-1 (the stirring vessel of which had a volume of 8.3 cc), was used. The temperature of the stirring vessel was controlled to 1° C., 15° C., 25° C., or 35° C. A pair of stirring blades was rotated at 2,000 rpm. The pigment solution was added from one feed port of the stirring vessel to the stirring vessel at a flow rate of 10 ml/min, the poor solvent was added from another feed port of the stirring vessel to the stirring vessel at a flow rate of 100 ml/min, and 1,000 ml of an organic pigment particle dispersion liquid taken out of a discharge port was collected. Dispersion liquids obtained at the respective temperatures are designated to as Sample Pigment Liquids (105) to (108).

### Comparative Example 1-1

The pigment solution was prepared in the same manner as in Example 1-1, and water was provided as a poor solvent.

An organic pigment particle dispersion liquid was prepared, by injecting 1 ml of the pigment solution over one second, into 10 ml of water as the poor solvent stirred in a beaker with a stirring bar at 2,000 rpm and at a temperature controlled to 1° C., 15° C., 25° C., 35° C., or 50° C. Dispersion liquids obtained at the respective temperatures are designated to as Sample Pigment Liquids (109) to (112).

### Comparative Example 1-2

The pigment solution was prepared in the same manner as in Example 1-1, and water was provided as a poor solvent.

An organic pigment particle dispersion liquid was prepared, by injecting 100 ml of the pigment solution at a flow rate of 50 ml/min with NP-KX-500 type large-volume pulseless pump manufactured by Nihon Seimitsu Kagaku Co., Ltd., into 1,000 ml of water as the poor solvent stirred in a beaker with GK-0222-10 type Ramond Stirrer manufactured by Fujisawa Pharmaceutical Co., Ltd. at 2,000 rpm and at a temperature controlled to 1° C., 15° C., 25° C., 35° C., or 50° C. Dispersion liquids obtained at the respective temperatures are designated to as Sample Pigment Liquids (113) to (116).

### Test Example 1

The particle diameters of Sample Pigment Liquids (101) to (116) were measured with Nanotrac UPA-EX 150 manufactured by NIKKISO CO., LTD., and each liquid was evaluated for average particle diameter and degree of monodispersion. Evaluation for the average particle diameter was performed on the basis of a number average particle diameter Mn. Evaluation for the degree of monodispersion was performed on the basis of a value (Mv/Mn) obtained by dividing a volume average particle diameter Mv by Mn. Table 1-1 shows the results.

Each of Sample Pigment Liquids (101) to (116) was subjected to centrifugal separation with a high-speed centrifugal refrigerating machine HIMAC SCR20B manufactured by Hitachi Koki Co., Ltd. under the conditions of at 3,500 rpm (2,000 g) for 1 hour. Then, the supernatant was discarded, and the sedimented organic pigment particle concentrated paste was collected. Water was added to the resultant paste, to adjust a pigment content to 15%. After that, the resultant mixture was redispersed with an ultrasonic cleaner W-103T manufactured by HONDA, and the average particle diameter of the resultant dispersion was measured with Nanotrac UPA-EX 150 manufactured by NIKKISO CO., LTD. The pigment content was measured with an 8453 type spectrophotometer manufactured by Agilent. Table 1-1 shows the results.

### [Table 1-1]

TABLE 1-1

| | | | | | Number average | Degree of |
|---|---|---|---|---|---|---|
| Sample | | | Number average | Degree of | particle diameter | monodispersion |
| pigment | | Poor solvent | particle diameter | monodispersion | after concentration | after concentration |
| liquid | | temperature (° C.) | Mn (nm) | (Mv/Mn) | Mn (nm) | (Mv/Mn) |
| (101) | This | 1 | 20 | 1.25 | 20 | 1.25 |
| (102) | invention | 15 | 20 | 1.25 | 21 | 1.26 |
| (103) | 1-1 | 25 | 21 | 1.26 | 22 | 1.26 |
| (104) | | 35 | 22 | 1.27 | 22 | 1.27 |
| (105) | This | 1 | 20 | 1.24 | 21 | 1.25 |
| (106) | invention | 15 | 21 | 1.25 | 21 | 1.25 |
| (107) | 1-2 | 25 | 21 | 1.26 | 22 | 1.26 |
| (108) | | 35 | 22 | 1.26 | 22 | 1.27 |
| (109) | Comparative | 1 | 20 | 1.31 | 20 | 1.31 |
| (110) | example 1-1 | 15 | 21 | 1.31 | 22 | 1.32 |
| (111) | | 25 | 25 | 1.39 | 26 | 1.39 |
| (112) | | 35 | 46 | 1.51 | 46 | 1.53 |
| (113) | Comparative | 1 | 20 | 1.31 | 21 | 1.31 |
| (114) | example 1-2 | 15 | 21 | 1.31 | 22 | 1.32 |
| (115) | | 25 | 25 | 1.40 | 25 | 1.40 |
| (116) | | 35 | 47 | 1.52 | 48 | 1.54 |

The above results show that monodisperse organic nanoparticles can be stably produced in a wide temperature range of 1° C. to 35° C., according to the method and apparatus of producing organic particles of the present invention.

In the case of a reprecipitation method as a conventional method involving injecting a sample that has been dissolved in a good solvent, into a poor solvent, with its stirring conditions or temperature controlled, organic nanoparticles can be produced even at room temperature, but the size of the particles is found to largely depend on temperature. In particular, the stable production of organic pigment particles requires sufficient cooling of a poor solvent, and the mass production of such particles on an industrial scale requires a cooling plant, so a significant increase in cost is found to occur.

In contrast, the method and apparatus of producing organic particles of the present invention are each found to be extremely favorable for the mass production of organic particles, since each of the method and the apparatus enables the stable production of monodisperse organic particles in a wide temperature range of 1° C. to 35° C., and eliminates the need for a cooling plant. Further, each of the method and the apparatus is found to enable the production, on an industrial scale, of an organic particle dispersion mixed liquid favorable for a color filter coating liquid or for ink-jet ink, since each of the method and the apparatus enables the concentration of organic particles without any changes in its particle diameter and degree of monodispersion.

### Example 2-1

A 15-mmol/L pigment solution was prepared by dissolving a pigment (Pigment Red 254) in a solution prepared by mixing 1-methyl-2-pyrrolidone and a 1-mol/L aqueous sodium hydroxide solution at a ratio of 6:1. Water was separately provided as a poor solvent.

3,000 ml of water as the poor solvent was charged into a cylindrical reaction container having a hemispherical bottom portion of diameter 250 mm and depth 320 mm. A mixer, as shown in FIG. 3-3 (measuring 60 mm long, 60 mm wide, and 30 mm high), was provided in the liquid so that its lower end would reach a position at a height of 35 mm from the bottom portion of the reaction container. An organic pigment particle dispersion liquid was prepared, by adding 300 ml of the pigment solution at a flow rate of 50 ml/min to the poor solvent stirred at 1,000 rpm in the mixer and at a temperature controlled to 1° C., 15° C., 25° C., or 35° C. Dispersion liquids obtained at the respective temperatures are designated to as Sample Pigment Liquids (201) to (204).

### Example 2-2

A 150-mmol/L pigment solution was prepared by dissolving a pigment (Pigment Red 254) in a solution prepared by mixing dimethylsulfoxide and a 8-mol/L aqueous sodium hydroxide solution at a ratio of 6:1. Water was separately provided as a poor solvent.

3,000 ml of water as the poor solvent was charged into a cylindrical reaction container having a mixer as that of Example 2-1. An organic pigment particle dispersion liquid was prepared, by adding 300 ml of the pigment solution at a flow rate of 50 ml/min to the poor solvent stirred in the mixer at 1,000 rpm and at a temperature controlled to 1° C., 15° C., 25° C., or 35° C. Dispersion liquids obtained at the respective temperatures are designated to as Sample Pigment Liquids (205) to (208).

### Comparative Example 2-1

The pigment solution was prepared in the same manner as in Example 2-1, and water was provided as a poor solvent.

An organic pigment particle dispersion liquid was prepared, by injecting 1 ml of the pigment solution over one second, into 10 ml of water as the poor solvent stirred in a beaker with a stirring bar at 1,000 rpm and at a temperature controlled to 1° C., 15° C., 25° C., or 35° C. Dispersion liquids obtained at the respective temperatures are designated to as Sample Pigment Liquids (209) to (212).

### Comparative Example 2-2

The pigment solution was prepared in the same manner as in Example 2-1, and water was provided as a poor solvent.

An organic pigment particle dispersion liquid was prepared, by injecting 300 ml of the pigment solution at a flow rate of 50 ml/min with NP-KX-500 type large-volume pulseless pump manufactured by Nihon Seimitsu Kagaku Co., Ltd., into 3,000 ml of water as the poor solvent stirred in a beaker with GK-0222-10 type Ramond Stirrer manufactured by Fujisawa Pharmaceutical Co., Ltd. at 1,000 rpm and at a temperature controlled to 1° C., 15° C., 25° C., or 35° C. Dispersion liquids obtained at the respective temperatures are designated to as Sample Pigment Liquids (213) to (216).

### Test Example 2

The particle diameters of Sample Pigment Liquids (201) to (216) were measured with Nanotrac UPA-EX 150 manufactured by NIKKISO CO., LTD., and each liquid was evaluated for average particle diameter and degree of monodispersion. Evaluation for the average particle diameter was performed on the basis of a number average particle diameter Mn. Evaluation for the degree of monodispersion was performed on the basis of a value (Mv/Mn) obtained by dividing a volume average particle diameter Mv by Mn. Table 2-1 shows the results.

Each of Sample Pigment Liquids (201) to (216) was subjected to centrifugal separation with a high-speed centrifugal refrigerating machine HIMAC SCR20B manufactured by Hitachi Koki Co., Ltd. under the conditions of at 3,500 rpm (corresponding to a centrifugal force 2,000 times as large as the gravitational acceleration) for 1 hour. Then, the supernatant was discarded, and the sedimented organic pigment particle concentrated paste was collected. Water was added to the resultant paste, to adjust a pigment content to 15%. After that, the resultant mixture was redispersed with an ultrasonic cleaner W-103T manufactured by HONDA, and the average particle diameter of the resultant dispersion was measured with Nanotrac UPA-EX 150 manufactured by NIKKISO CO., LTD. The pigment content was measured with an 8453 type spectrophotometer manufactured by Agilent. Table 2-1 shows the results.

### [Table 2-1]

TABLE 2-1

| | | | | | Number average | Degree of |
|---|---|---|---|---|---|---|
| | | | | | particle diameter | monodispersion |
| Sample | | | Number average | Degree of | after concentration | after concentration |
| pigment | | Poor solvent | particle diameter | monodispersion | and redispersion | and redispersion |
| liquid | | temperature (° C.) | Mn (nm) | (Mv/Mn) | Mn (nm) | (Mv/Mn) |
| (201) | This | 1 | 20 | 1.30 | 20 | 1.30 |
| (202) | invention | 15 | 20 | 1.31 | 21 | 1.31 |
| (203) | 2-1 | 25 | 21 | 1.32 | 22 | 1.32 |
| (204) | | 35 | 22 | 1.33 | 22 | 1.34 |
| (205) | This | 1 | 20 | 1.31 | 21 | 1.31 |
| (206) | invention | 15 | 21 | 1.31 | 21 | 1.31 |
| (207) | 2-2 | 25 | 21 | 1.32 | 22 | 1.32 |
| (208) | | 35 | 22 | 1.33 | 22 | 1.33 |
| (209) | Comparative | 1 | 20 | 1.31 | 21 | 1.31 |
| (210) | example 2-1 | 15 | 21 | 1.31 | 22 | 1.33 |
| (211) | | 25 | 25 | 1.39 | 26 | 1.39 |
| (212) | | 35 | 46 | 1.51 | 46 | 1.53 |
| (213) | Comparative | 1 | 20 | 1.31 | 21 | 1.31 |
| (214) | example 2-2 | 15 | 21 | 1.31 | 22 | 1.32 |
| (215) | | 25 | 25 | 1.40 | 26 | 1.41 |
| (216) | | 35 | 47 | 1.52 | 48 | 1.55 |

The above results show that monodisperse organic particles can be stably produced in a wide temperature range of 1° C. to 35° C., according to the method and apparatus of producing organic particles of the present invention.

In the case of a reprecipitation method as a conventional method involving injecting a sample that has been dissolved in a good solvent, into a poor solvent, with its stirring conditions or temperature controlled, organic particles can be produced even at room temperature, but the size of the particles is found to largely depend on temperature. In particular, the stable production of organic pigment particles requires sufficient cooling of a poor solvent, and the mass production of such particles on an industrial scale requires a cooling plant, so a significant increase in cost is found to occur.

In contrast, the method and apparatus of producing organic particles of the present invention are each found to be extremely favorable for the mass production of organic particles, since each of the method and the apparatus enables the stable production of monodisperse organic particles in a wide temperature range of 1° C. to 35° C., and eliminates the need for a cooling plant. Further, each of the method and the apparatus is found to enable the production, on an industrial scale, of an organic particle mixed dispersion liquid favorable for a color filter coating liquid or for ink-jet ink, since each of the method and the apparatus enables the concentration of organic particles without any changes in its particle diameter and degree of monodispersion.

### Example 3-1

A 15-mmol/L pigment solution was prepared by dissolving a pigment (Pigment Red 254) in a solution prepared by mixing 1-methyl-2-pyrrolidone and a 1-mol/L aqueous sodium hydroxide solution at a ratio of 6:1. Water was separately provided as a poor solvent.

The temperature of a stirring vessel was controlled to 1° C., 15° C., 25° C., or 35° C. An organic pigment particle dispersion liquid was prepared by adding 100 ml of the pigment solution by gravity drop with a funnel, to 1,000 ml of water as the poor solvent stirred at 700 rpm in a beaker with a dissolver stirring blade (having a radius of 3 cm), to obtain Sample Pigment Liquids (301) to (304), respectively.

### Example 3-2

The pigment solution was prepared in the same manner as in Example 3-1, and water was provided as a poor solvent.

The temperature of a stirring vessel was controlled to 1° C., 15° C., 25° C., or 35° C. An organic pigment particle dispersion liquid was prepared by adding 100 ml of the pigment solution by gravity drop with a funnel, to 1,000 ml of water as the poor solvent stirred at 700 rpm in a beaker with a Physcotron manufactured by Microtec Co., Ltd., to obtain Sample Pigment Liquids (305) to (308), respectively.

### Example 3-3

A 150-mmol/L pigment solution was prepared by dissolving a pigment (Pigment Red 254) in a solution prepared by mixing dimethylsulfoxide and a 8-mol/L aqueous sodium hydroxide solution at a ratio of 6:1. Water was separately provided as a poor solvent.

The temperature of a stirring vessel was controlled to 1° C., 15° C., 25° C., or 35° C. An organic pigment particle dispersion liquid was prepared by adding 100 ml of the pigment solution by gravity drop with a funnel, to 1,000 ml of water as the poor solvent stirred at 700 rpm in a beaker with a dissolver stirring blade (having a radius of 3 cm), to obtain Sample Pigment Liquids (309) to (312), respectively.

### Example 3-4

The pigment solution was prepared in the same manner as in Example 3-3, and water was provided as a poor solvent.

The temperature of a stirring vessel was controlled to 1° C., 15° C., 25° C., or 35° C. An organic pigment particle dispersion liquid was prepared by adding 100 ml of the pigment solution by gravity drop with a funnel, to 1,000 ml of water as the poor solvent stirred at 700 rpm in a beaker with a Physcotron manufactured by Microtec Co., Ltd., to obtain Sample Pigment Liquids (313) to (316), respectively.

### Comparative Example 3-1

The pigment solution was prepared in the same manner as in Example 3-1, and water was provided as a poor solvent.

An organic pigment particle dispersion liquid was prepared, by injecting 1 ml of the pigment solution in one stroke, into 10 ml of water as the poor solvent stirred in a beaker with a stirring bar at 1,000 rpm and at a temperature controlled to 1° C., 15° C., 25° C., or 35° C., to obtain Sample Pigment Liquids (317) to (320), respectively.

### Comparative Example 3-2

The pigment solution was prepared in the same manner as in Example 3-1, and water was provided as a poor solvent.

An organic pigment particle dispersion liquid was prepared, by injecting 100 ml of the pigment solution at a flow rate of 50 ml/min with NP-KX-500 type large-volume pulseless pump manufactured by Nihon Seimitsu Kagaku Co., Ltd., into 1,000 ml of water as the poor solvent stirred in a beaker with GK-0222-10 type Ramond Stirrer manufactured by Fujisawa Pharmaceutical Co., Ltd. at 700 rpm and at a temperature controlled to 1° C., 15° C., 25° C., 35° C., or 50° C., to obtain Sample Pigment Liquids (321) to (324), respectively.

The particle diameters of Sample Pigment Liquids (1) to (24) were measured with Nanotrac UPA-EX 150 manufactured by NIKKISO CO., LTD., and each liquid was evaluated for average particle diameter and degree of monodispersion. Evaluation for the average particle diameter was performed on the basis of a number average particle diameter Mn. Evaluation for the degree of monodispersion was performed on the basis of a value (Mv/Mn) obtained by dividing a volume average particle diameter Mv by Mn. Table 3-1 shows the results.

Each of Sample Pigment Liquids (301) to (324) was subjected to centrifugal separation with a high-speed centrifugal refrigerating machine HIMAC SCR20B manufactured by Hitachi Koki Co., Ltd. under the conditions of at 3,500 rpm (2,000 g) for 1 hour. Then, the supernatant was discarded, and the sedimented pigment nanoparticle concentrated paste was collected. Water was added to the resultant paste, to adjust a pigment content to 15%. After that, the resultant mixture was redispersed with an ultrasonic cleaner W-103T manufactured by HONDA, and the average particle diameter of the resultant dispersion was measured with Nanotrac UPA-EX 150 manufactured by NIKKISO CO., LTD. The pigment content was measured with an 8453 type spectrophotometer manufactured by Agilent. Table 3-1 shows the results.

### [Table 3-1]

TABLE 3-1

| | | | | | Number average | Degree of |
|---|---|---|---|---|---|---|
| Sample | | | Number average | Degree of | particle diameter | monodispersion |
| pigment | | Poor solvent | particle diameter | monodispersion | after concentration | after concentration |
| liquid | | temperature (° C.) | Mn (nm) | (Mv/Mn) | Mn (nm) | (Mv/Mn) |
| (301) | This | 1 | 20 | 1.30 | 20 | 1.31 |
| (302) | invention | 15 | 20 | 1.31 | 21 | 1.31 |
| (303) | 3-1 | 25 | 21 | 1.31 | 21 | 1.32 |
| (304) | | 35 | 22 | 1.32 | 22 | 1.32 |
| (305) | This | 1 | 20 | 1.30 | 20 | 1.31 |
| (306) | invention | 15 | 21 | 1.31 | 21 | 1.31 |
| (307) | 3-2 | 25 | 21 | 1.32 | 22 | 1.32 |
| (308) | | 35 | 22 | 1.33 | 22 | 1.33 |
| (309) | This | 1 | 20 | 1.31 | 20 | 1.31 |
| (310) | invention | 15 | 21 | 1.31 | 21 | 1.31 |
| (311) | 3-3 | 25 | 22 | 1.32 | 22 | 1.32 |
| (312) | | 35 | 22 | 1.32 | 22 | 1.33 |
| (313) | This | 1 | 20 | 1.31 | 20 | 1.31 |
| (314) | invention | 15 | 21 | 1.31 | 21 | 1.32 |
| (315) | 3-4 | 25 | 21 | 1.32 | 21 | 1.32 |
| (316) | | 35 | 22 | 1.32 | 22 | 1.33 |
| (317) | Comparative | 1 | 20 | 1.31 | 20 | 1.31 |
| (318) | example 3-1 | 15 | 21 | 1.31 | 22 | 1.31 |
| (319) | | 25 | 25 | 1.39 | 26 | 1.40 |
| (320) | | 35 | 46 | 1.51 | 47 | 1.52 |
| (321) | Comparative | 1 | 20 | 1.31 | 20 | 1.31 |
| (322) | example 3-2 | 15 | 21 | 1.31 | 22 | 1.32 |
| (323) | | 25 | 25 | 1.40 | 26 | 1.41 |
| (324) | | 35 | 47 | 1.52 | 48 | 1.53 |

The above results show that monodisperse organic particles can be stably produced in a wide temperature range of 1° C. to 35° C., according to the method and apparatus of producing organic particles of the present invention.

In the case of a reprecipitation method as a conventional method involving injecting a sample that has been dissolved in a good solvent, into a poor solvent, with its stirring conditions or temperature controlled, organic nanoparticles can be produced even at room temperature, but the size of the particles is found to largely depend on temperature. In particular, the stable production of organic pigment particles requires sufficient cooling of a poor solvent, and the mass production of such particles on an industrial scale requires a cooling plant, so a significant increase in cost is found to occur.

In contrast, the method and apparatus of producing organic particles of the present invention are each found to be extremely favorable for the mass production of organic particles, since each of the method and the apparatus enables the stable production of monodisperse organic particles in a wide temperature range of 1° C. to 35° C., and eliminates the need for a cooling plant. Further, each of the method and the apparatus is found to enable the production, on an industrial scale, of an organic particle dispersion liquid favorable for a color filter coating liquid or for ink-jet ink, since each of the method and the apparatus enables the concentration of organic particles without any changes in its particle diameter and degree of monodispersion.

### Example 4

In Example 4 below, the average particle diameter of organic pigment particles was determined as follows: after a dispersion liquid had been dried on filter paper, the particle diameters of 100 particles were measured with a scanning electron microscope, and the number average particle diameter of the particles was determined. Further, the ratio Mv/Mn as an index of monodispersity was measured with Nanotrac UPA-EX 150 manufactured by NIKKISO CO., LTD.

### (Preparation of Dispersion Liquid)

[Dispersion liquid (401)]

In order to prepare 1,100 ml of an organic pigment particle dispersion liquid having a ratio of a pigment solution to a poor solvent (good solvent/poor solvent) of 1/10, a pigment solution was prepared by dissolving 530 mg of a pigment (Pigment Red 254) and 8 ml of 1-mol/l sodium hydroxide in 100 ml of 1-methyl-2-pyrrolidone. 1,000 ml of water containing 8 ml of 1-mol/l hydrochloric acid were separately provided as a poor solvent.

Then, an organic pigment particle dispersion liquid was prepared, by injecting the whole amount of the pigment solution at a flow rate of 50 ml/min with NP-KX-500 type large-volume pulseless pump manufactured by Nihon Seimitsu Kagaku Co., Ltd., into the poor solvent stirred at 500 rpm with GK-0222-10 type Ramond Stirrer manufactured by Fujisawa Pharmaceutical Co., Ltd. and at a temperature controlled to 1° C. The resultant dispersion was designated to as Dispersion liquid (401). The particle diameters of the particles in the dispersion liquid and the ratio Mv/Mn of the dispersion liquid immediately after the preparation were measured.

### [Dispersion Liquid (402)]

Further, in order to prepare 1,300 ml of an organic pigment particle dispersion liquid having a ratio of a pigment solution to a poor solvent (good solvent/poor solvent) of 3/10, a pigment solution was prepared by dissolving 1,590 mg of a pigment (Pigment Red 254) and 24 ml of 1-mol/l sodium hydroxide in 300 ml of 1-methyl-2-pyrrolidone. 1,000 ml of water containing 24 ml of 1-mol/l hydrochloric acid were separately provided as a poor solvent. Then, an organic pigment particle dispersion liquid was prepared in the same manner as Dispersion liquid (401). The resultant dispersion liquid was designated to as Dispersion liquid (402). The particle diameters of the particles in the dispersion liquid and the ratio Mv/Mn of the dispersion liquid immediately after the preparation were measured.

### [Dispersion Liquid (403)]

Further, in order to prepare 3,300 ml of an organic pigment particle dispersion liquid having a ratio of a pigment solution to a poor solvent (good solvent/poor solvent) of 1/10, a pigment solution was prepared by dissolving 1,590 mg of a pigment (Pigment Red 254) and 24 ml of 1-mol/l sodium hydroxide in 300 ml of 1-methyl-2-pyrrolidone (NMP). 3,000 ml of water containing 24 ml of 1-mol/l hydrochloric acid were separately provided as a poor solvent. Then, an organic pigment particle dispersion liquid was prepared in the same manner as Dispersion liquid (401). The resultant dispersion liquid was designated to as Dispersion liquid (403). The particle diameters of the particles in the dispersion liquid and the ratio Mv/Mn of the dispersion liquid immediately after the preparation were measured.

### [Dispersion Liquid (404)]

Further, in order to prepare 3,900 ml of an organic pigment particle dispersion liquid having a ratio of a pigment solution to a poor solvent (good solvent/poor solvent) of 3/10, a pigment solution was prepared by dissolving 4,770 mg of a pigment (Pigment Red 254) and 72 ml of 1-mol/l sodium hydroxide in 900 ml of 1-methyl-2-pyrrolidone. 3,000 ml of water containing 72 ml of 1-mol/l hydrochloric acid were separately provided as a poor solvent. Then, an organic pigment particle dispersion liquid was prepared in the same manner as Dispersion liquid (401). The resultant dispersion liquid was designated to as Dispersion liquid (404). The particle diameters of the particles in the dispersion liquid and the ratio Mv/Mn of the dispersion liquid immediately after the preparation were measured.

### [Dispersion Liquid (405)]

Further, in order to prepare 9,900 ml of an organic pigment particle dispersion liquid having a ratio of a pigment solution to a poor solvent (good solvent/poor solvent) of 1/10, a pigment solution was prepared by dissolving 4,770 mg of a pigment (Pigment Red 254) and 72 ml of 1-mol/l sodium hydroxide in 900 ml of 1-methyl-2-pyrrolidone (NMP). 9,000 ml of water containing 72 ml of 1-mol/l hydrochloric acid were separately provided as a poor solvent. Then, an organic pigment particle dispersion liquid was prepared in the same manner as Dispersion liquid (401). The resultant dispersion liquid was designated to as Dispersion liquid (405). The particle diameters of the particles in the dispersion liquid and the ratio Mv/Mn of the dispersion liquid immediately after the preparation were measured.

### [Dispersion Liquid (406)]

Further, in order to prepare 11,700 ml of an organic pigment particle dispersion liquid having a ratio of a pigment solution to a poor solvent (good solvent/poor solvent) of 3/10, a pigment solution was prepared by dissolving 14,310 mg of a pigment (Pigment Red 254) and 216 ml of 1-moll sodium hydroxide in 2,700 ml of 1-methyl-2-pyrrolidone. 9,000 ml of water containing 216 ml of 1-mol/l hydrochloric acid were separately provided as a poor solvent. Then, an organic pigment particle dispersion liquid was prepared in the same manner as Dispersion liquid (401). The resultant dispersion liquid was designated to as Dispersion liquid (406). The particle diameters of the particles in the dispersion liquid and the ratio Mv/Mn of the dispersion liquid immediately after the preparation were measured.

### [Dispersion Liquid (407)]

Further, 300 ml of a 150-mmol/L pigment solution were prepared by dissolving a pigment (Pigment Red 254) in a solution prepared by mixing dimethyl sulfoxide (DMSO) and an 8-mol/l aqueous potassium hydroxide solution at a weight ratio of 6:1. 3,000 ml of water were separately provided as a poor solvent. Then, an organic pigment particle dispersion liquid was prepared in the same manner as Dispersion liquid (401). The dispersion liquid was designated to as Dispersion liquid (407). The particle diameters of the particles in the dispersion liquid and the ratio Mv/Mn of the dispersion liquid immediately after the preparation were measured.

### Example 4-1

Each of the thus-prepared Dispersion Liquids (401) to (407) was subjected to centrifugal separation with a high-speed centrifugal refrigerating machine HIMAC SCR20B manufactured by Hitachi Koki Co., Ltd. under the conditions of at 3,500 rpm (corresponding to a centrifugal force 2,000 times as large as the gravitational acceleration) for 1 hour. Then, the supernatant was discarded, and the sedimented organic pigment particle concentrated pastes (a1) to(a7) according to the present invention were collected. The pigment content of each paste was measured with an 8453 type spectrophotometer manufactured by Agilent. As a result, Concentrated Pastes (a1), (a2), (a3), (a4), (a5), (a6), and (a7) had pigment contents of 28, 27, 27, 28, 29, 27, and 30 mass %, respectively.

The average primary particle diameter of the organic pigment particles in each concentrated paste was determined by observation with a scanning electron microscope in the same manner as in the foregoing (shown in the column “primary particle diameter after concentration” in each table). Further, water in an amount 20 times as large as a pigment weight was added to each paste, and then the average aggregated particle diameter of each paste was measured with Nanotrac UPA-EX 150 manufactured by NIKKISO CO., LTD. Then, a redispersion index was determined from the average aggregated particle diameter and the average primary particle diameter (shown in the column “redispersion index” in each table).

Then, furthermore, aggregated pigment particles were dispersed into primary particles by being irradiated with an ultrasonic wave from a Model 200 bdc-h40:0.8 type ultrasonic homogenizer manufactured by Branson Ultrasonics Division of Emerson Japan Ltd. for 1 hour. After that, the ratio Mv/Mn was measured again with Nanotrac UPA-EX 150 manufactured by NIKKISO CO., LTD. (shown in the column “Mv/Mn after concentration” in each table).

### Example 4-2

With respect to the resultant Dispersion liquids (401) to (407), by using DP-32 type vacuum dryer manufactured by Yamato Scientific Co., Ltd., the paste of each of Dispersion liquids (401) and (402) was concentrated by drying under reduced pressure at 120° C. for 10 minutes; the paste of each of Dispersion liquids (403), (404), and (407) was concentrated by drying under reduced pressure at 120° C. for 30 minutes; the paste of each of Dispersion liquids (405) and (406) was concentrated by drying under reduced pressure at 120° C. for 90 minutes. Thus, Organic pigment particle concentrated pastes (b1) to (b7) were obtained. The pigment content of each paste was measured in the same manner as in Example 4-1. As a result, Concentrated Pastes (b1), (b2), (b3), (b4), (b5), (b6), and (b7) had pigment contents of 32, 32, 30, 30, 30, 31, and 34 mass %, respectively. Tables 4-1 to 4-7 show the results of the “primary particle diameter after concentration”, “Mv/Mn after concentration”, and “redispersion index” of each of Concentrated Pastes (b1) to (b7) measured in the same manner as in Example 4-1.

### Example 4-3

After the preparation of Dispersion liquids (401) to (407), 2-(1-methoxy)propylacetate was added in an amount of 500 ml to Dispersion (401), 590 ml to Dispersion (402), 1,500 ml to Dispersion (403), 1770 ml to Dispersion (404), 4,500 ml to Dispersion (405), 5,320 ml to Dispersion (406), and 1,500 ml to Dispersion (407), respectively, and the whole mixture was stirred at 20° C. for 10 minutes at 100 rpm, to carry out extraction of organic pigment particles in a 2-(1-methoxy)propylacetate phase, respectively. Thus, Concentrated extract liquids (c1) to (c7) were obtained. The content of organic pigment particles in a dispersion solvent remaining after the extraction was reduced to about 5 mass % or less.

Concentrated extract liquids (c1) to (c7) were each subjected to centrifugal separation under the same conditions as to those in Example 4-1, thereby Organic pigment particle concentrated pastes (d1) to (d7) were obtained. The pigment content of each paste was measured in the same manner as in Example 4-1. As a result, Concentrated Pastes (d1), (d2), (d3), (d4), (d5), (d6), and (d7) had pigment contents of 30, 29, 28, 29, 27, 27, and 30 mass %, respectively. Tables 4-1 to 4-7 show the results of the “primary particle diameter after concentration”, “Mv/Mn after concentration”, and “redispersion index” of each of Concentrated Pastes (d1) to (d7) measured in the same manner as in Example 4-1.

### Example 4-4

Organic pigment particle concentrated extract liquids (c1) to (c7) were each produced in the same manner as in Example 4-3. After that, each of the extracts was dried under reduced pressure under the same conditions as to those in Example 4-2, thereby Organic pigment particle concentrated pastes (e1) to (e7) were obtained. The pigment content of each paste was measured in the same manner as in Example 4-1. As a result, Dispersion liquids (e1), (e2), (e3), (e4), (e5), (e6), and (e7) had pigment contents of 36, 36, 36, 34, 33, 34, and 37 mass %, respectively. Tables 4-1 to 4-7 show the results of the “primary particle diameter after concentration”, “Mv/Mn after concentration”, and “redispersion index” of each of Concentrated Pastes (e1) to (e7) measured in the same manner as in Example 4-1.

### Comparative Example 4-1

Each of Dispersion liquids (401) to (407) was filtrated through FP010 type filter manufactured by SUMITOMO ELECTRIC FINE POLYMER INC., thereby Organic pigment particle concentrated pastes (f1) to (f7) were obtained. The pigment content of each paste was measured in the same manner as in Example 4-1. As a result, Dispersion liquids (f1), (f2), (f3), (f4), (f5), (f6), and (f7) had pigment contents of 33, 31, 33, 34, 31, 30, and 34 mass %, respectively. Tables 4-1 to 4-7 show the results of the “primary particle diameter after concentration”, “Mv/Mn after concentration”, and “redispersion index” of each of Concentrated Pastes (f1) to (f7) measured in the same manner as in Example 4-1.

### Comparative Example 4-2

Organic pigment particle concentrated extract liquids (c1) to (c7) were each produced in the same manner as in Example 4-3. Each of the produced organic pigment particle concentrated extract liquids was filtrated in the same manner as in Comparative Example 4-1, thereby Organic pigment particle concentrated pastes (g1) to (g7) were obtained. The pigment content of each paste was measured in the same manner as in Example 4-1. As a result, Concentrated Pastes (g1), (g2), (g3), (g4), (g5), (g6), and (g7) had pigment contents of 34, 35, 32, 32, 31, 30, and 31 mass %, respectively. With respect to the Concentrated Pastes (g1) to (g7), the “primary particle diameter after concentration”, “Mv/Mn after concentration”, and “redispersion index” were measured in the same manner as in Example 4-1. Tables 4-1 to 4-7 show the results of those.

### Comparative Example 4-3

Using DP-32 type vacuum dryer manufactured by Yamato Scientific Co., Ltd., each of the Dispersion liquids (401) and (407) was concentrated by drying only under heating, but not conducting under a reduced pressure, for Dispersion liquids (401) and (402) at 120° C. for 60 minutes; for Dispersion liquids (403), (404), and (407) at 120° C. for 180 minutes; and for Dispersion liquids (405) and (406) at 120° C. for 540 minutes. Thus, Organic pigment particle concentrated pastes (h1) to (h7) were obtained. The pigment content of each paste was measured in the same manner as in Example 4-1. As a result, Dispersion liquids (h1), (h2), (h3), (h4), (h5), (h6), and (h7) had pigment contents of 28, 27, 25, 26, 25, 25, and 28 mass %, respectively. With respect to the Concentrated Pastes (h1) to (h7), the “primary particle diameter after concentration”, “Mv/Mn after concentration”, and “redispersion index” were measured in the same manner as in Example 4-1. Tables 4-1 to 4-7 show the results of those.

Furthermore, the organic pigment particles contained in each of Dispersion liquids (401) to (407) immediately after production had particle diameters of about 20 nm and a ratio Mv/Mn of 1.4.

### [Table 4-1]

TABLE 4-1

| | | Good solvent/Poor solvent | | |
|---|---|---|---|---|
| | | 1/10 (NMP/Water) | | |
| | | Amount of dispersion liquid | | |
| | | 1,100 ml | | |
| | | Primary particle diameter | Mv/Mn | Redispersion |
| | | after concentration (nm) | after concentration | index |
| Example 4-1 | Centrifugal separation | 20 | 1.4 | 1.3 |
| Example 4-2 | Drying under heat and reduced pressure | 20 | 1.4 | 1.5 |
| Example 4-3 | Extraction → Centrifugal separation | 21 | 1.4 | 1.2 |
| Example 4-4 | Extraction → Drying under heat and | 21 | 1.4 | 1.4 |
| | reduced pressure | | | |
| Comparative example 4-1 | Filter filtration | 28 | 1.5 | 2.1 |
| Comparative example 4-2 | Extraction → Filter filtration | 28 | 1.5 | 2.1 |
| Comparative example 4-3 | Drying under heat | 32 | 1.6 | 2.5 |

### [Table 4-2]

TABLE 4-2

| | | Good solvent/Poor solvent | | |
|---|---|---|---|---|
| | | 3/10 (NMP/Water) | | |
| | | Amount of dispersion | | |
| | | 1,300 ml | | |
| | | Primary particle diameter | Mv/Mn | Redispersion |
| | | after concentration (nm) | after concentration | index |
| Example 4-1 | Centrifugal separation | 20 | 1.4 | 1.5 |
| Example 4-2 | Drying under reduced pressure | 25 | 1.4 | 1.6 |
| Example 4-3 | Extraction → Centrifugal separation | 25 | 1.5 | 1.4 |
| Example 4-4 | Extraction → Drying under reduced pressure | 25 | 1.5 | 1.8 |
| Comparative example 4-1 | Filter filtration | 60 | 2.1 | 3.3 |
| Comparative example 4-2 | Extraction → Filter filtration | 55 | 2.1 | 4.0 |
| Comparative example 4-3 | Drying under heat | 45 | 1.9 | 4.2 |

### [Table 4-3]

TABLE 4-3

| | | Good solvent/Poor solvent | | |
|---|---|---|---|---|
| | | 1/10 (NMP/Water) | | |
| | | Amount of dispersion | | |
| | | 3,300 ml | | |
| | | Primary particle diameter | Mv/Mn | Redispersion |
| | | after concentration (nm) | after concentration | index |
| Example 4-1 | Centrifugal separation | 20 | 1.4 | 1.3 |
| Example 4-2 | Drying under heat and reduced pressure | 25 | 1.4 | 1.5 |
| Example 4-3 | Extraction → Centrifugal separation | 25 | 1.5 | 1.2 |
| Example 4-4 | Extraction → Drying under heat and | 25 | 1.5 | 1.4 |
| | reduced pressure | | | |
| Comparative example 4-1 | Filter filtration | 35 | 1.6 | 2.9 |
| Comparative example 4-2 | Extraction → Filter filtration | 40 | 1.7 | 2.8 |
| Comparative example 4-3 | Drying under heat | 40 | 1.7 | 2.5 |

### [Table 4-4]

TABLE 4-4

| | | Good solvent/Poor solvent | | |
|---|---|---|---|---|
| | | 3/10 (NMP/Water) | | |
| | | Amount of dispersion | | |
| | | 3,900 ml | | |
| | | Primary particle diameter | Mv/Mn | Redispersion |
| | | after concentration (nm) | after concentration | index |
| Example 4-1 | Centrifugal separation | 22 | 1.4 | 1.5 |
| Example 4-2 | Drying under reduced pressure | 25 | 1.4 | 1.6 |
| Example 4-3 | Extraction → Centrifugal separation | 26 | 1.5 | 1.5 |
| Example 4-4 | Extraction → Drying under reduced pressure | 26 | 1.5 | 1.8 |
| Comparative example 4-1 | Filter filtration | 75 | 2.2 | 3.5 |
| Comparative example 4-2 | Extraction → Filter filtration | 70 | 2.2 | 4.0 |
| Comparative example 4-3 | Drying under heat | 50 | 2.0 | 4.2 |

### [Table 4-5]

TABLE 4-5

| | | Good solvent/Poor solvent | | |
|---|---|---|---|---|
| | | 1/10 (NMP/Water) | | |
| | | Amount of dispersion | | |
| | | 9,900 ml | | |
| | | Primary particle diameter | Mv/Mn | Redispersion |
| | | after concentration (nm) | after concentration | index |
| Example 4-1 | Centrifugal separation | 21 | 1.4 | 1.4 |
| Example 4-2 | Drying under heat and reduced pressure | 25 | 1.4 | 1.5 |
| Example 4-3 | Extraction → Centrifugal separation | 26 | 1.5 | 1.4 |
| Example 4-4 | Extraction → Drying under heat and | 25 | 1.5 | 1.5 |
| | reduced pressure | | | |
| Comparative example 4-1 | Filter filtration | 40 | 1.6 | 3.0 |
| Comparative example 4-2 | Extraction → Filter filtration | 49 | 1.8 | 2.9 |
| Comparative example 4-3 | Drying under heat | 44 | 1.7 | 2.6 |

### [Table 4-6]

TABLE 4-6

| | | Good solvent/Poor solvent | | |
|---|---|---|---|---|
| | | 3/10 (NMP/Water) | | |
| | | Amount of dispersion | | |
| | | 11,700 ml | | |
| | | Primary particle diameter | Mv/Mn | Redispersion |
| | | after concentration (nm) | after concentration | index |
| Example 4-1 | Centrifugal separation | 24 | 1.4 | 1.6 |
| Example 4-2 | Drying under reduced pressure | 26 | 1.4 | 1.5 |
| Example 4-3 | Extraction → Centrifugal separation | 27 | 1.5 | 1.6 |
| Example 4-4 | Extraction → Drying under reduced pressure | 26 | 1.5 | 1.8 |
| Comparative example 4-1 | Filter filtration | 80 | 2.2 | 3.6 |
| Comparative example 4-2 | Extraction → Filter filtration | 76 | 2.3 | 4.1 |
| Comparative example 4-3 | Drying under heat | 54 | 2.1 | 4.2 |

### [Table 4-7]

TABLE 4-7

| | | Good solvent/Poor solvent | | |
|---|---|---|---|---|
| | | 1/10 (DMSO/Water) | | |
| | | Amount of dispersion | | |
| | | 3,300 ml | | |
| | | Primary particle diameter | Mv/Mn | Redispersion |
| | | after concentration (nm) | after concentration | index |
| Example 4-1 | Centrifugal separation | 21 | 1.4 | 1.3 |
| Example 4-2 | Drying under heat and reduced pressure | 21 | 1.4 | 1.4 |
| Example 4-3 | Extraction → Centrifugal separation | 22 | 1.4 | 1.4 |
| Example 4-4 | Extraction → Drying under heat and | 21 | 1.4 | 1.4 |
| | reduced pressure | | | |
| Comparative example 4-1 | Filter filtration | 50 | 1.7 | 3.1 |
| Comparative example 4-2 | Extraction → Filter filtration | 51 | 1.7 | 3.3 |
| Comparative example 4-3 | Drying under heat | 40 | 1.6 | 2.7 |

By employing centrifugal separation or drying under heat and reduced pressure, it was possible to concentrate the organic pigment particles without any change in its particle diameter and monodispersity, and give an organic pigment particle concentrated paste having good redispersibility. Further, upon increase in the volume ratio between a good solvent and a poor solvent (good solvent/poor solvent) or in the amount of a dispersion liquid to be concentrated, filter filtration concentration and drying under heat each resulted in a conspicuous increase in its particle diameter and conspicuous deterioration of its monodispersity or redispersibility upon the concentration. In contrast, neither centrifugal separation concentration nor concentration under heat and reduced pressure caused a large change in its particle diameter, monodispersity, or redispersibility.

That is, according to the production method of the present invention, the concentration of a dispersion can be performed at a high ratio of a good solvent to a poor solvent (good solvent/poor solvent) while the particle diameter, monodispersity, and redispersibility are maintained, thereby organic particles can be efficiently produced. Further, according to the production method of the present invention, even when the amount of a mixed dispersion liquids is increased by a magnification of 3 or 9, none of the particle diameter, monodispersity, and redispersibility is observed to depend on the scale on which organic particles are to be produced. As a result, the concentration of the dispersion liquid can be performed while they are maintained, thereby organic particles can be produced in large quantities. To be specific, the examples shown in Table 4-7 are examples when the pigment solution concentration of the examples shown in Table 4-3 is increased by a magnification of about 10; and filter filtration resulted in a conspicuous increase in its particle diameter and the conspicuous deterioration of its monodispersity or redispersibility due to the increase in concentration, while neither centrifugal separation concentration nor concentration under heat and reduced pressure caused a large change in its particle diameter, monodispersity, or redispersibility.

An increase in concentration of a good solvent is important for an increase in efficiency with which particles are produced, since a dispersion liquid concentration increases owing to the increased good solvent. According to the production method of the present invention, it can be understood that the concentrating of a dispersion liquid can be performed at a high solution concentration while the particle diameter, monodispersity, and redispersibility are maintained, thereby organic particles can be efficiently produced.

The reagents to be used are specifically the followings:

| Reagent | Manufacturer |
|---|---|
| Pigment Red 254 (Irgaphore Red) | Ciba Specialty Chemicals |
| 1-Methyl-2-pyrrolidone | Wako Pure Chemical Industries, Ltd. |
| Dimethylsulfoxide | Wako Pure Chemical Industries, Ltd. |
| 2-(1-Methoxy)propylacetate | Wako Pure Chemical Industries, Ltd. |
| 1-mol/l Aqueous sodium | Wako Pure Chemical Industries, Ltd. |
| hydroxide solution | |
| 1-mol/l Hydrochloric acid | Wako Pure Chemical Industries, Ltd. |
| 8-mol/l Aqueous potassium | Wako Pure Chemical Industries, Ltd. |
| hydroxide solution | |

### INDUSTRIAL APPLICABILITY

The organic particles, a concentrated organic particle paste, and the like, which are produced by the production method of the present invention, can be used as excellent industrial organic materials. For example, any such product can be used as favorable ink-jet ink or a raw material fine-particle of the ink, or a color filter coating liquid or a raw material fine-particle of the liquid.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. § 119 (a) on Patent Application No. 2005-213035 filed in Japan on Jul. 22, 2005, Patent Application No. 2005-213060 filed in Japan on Jul. 22, 2005, Patent Application No. 2005-213088 filed in Japan on Jul. 22, 2005, Patent Application No. 2005-213121 filed in Japan on Jul. 22, 2005, Patent Application No. 2005-136749 filed in Japan on May 9, 2005, Patent Application No. 2005-136748 filed in Japan on May 9, 2005, Patent Application No. 2005-136750 filed in Japan on May 9, 2005, and Patent Application No. 2005-136751 filed in Japan on May 9, 2005, each of which is entirely herein incorporated by reference.

1. A method of producing organic particles, comprising:
mixing a poor solvent for an organic material with a solution of the organic material dissolved in a good solvent, thereby to form particles of the organic material in a resultant liquid mixture, said poor solvent being compatible with the good solvent,
wherein the formation of the organic particles is conducted by any of the following processes a, b, and c:
[a] a process comprising: feeding the poor solvent and the solution of the organic material into a stirring vessel through predetermined numbers of liquid feed ports, respectively; mixing the poor solvent and the solution of the organic material under stirring in the stirring vessel, to form said organic particles; and taking out the liquid mixture containing the organic particles formed via the mixing under stirring;
[b] a process comprising: providing a stirring zone in part of a container filled with the poor solvent; feeding the solution of the organic material into the stirring zone; mixing the poor solvent and the solution of the organic material in the stirring zone under stirring, to form said organic particles; and making the organic particles flow out of the stirring zone into another zone of the container; and
[c] a process comprising: mixing the poor solvent and the solution of the organic material under the condition where a shearing force is applied.

2. The method of producing organic particles according to claim 1, wherein the process a includes: providing a pair of stirring blades placed at two opposing sites in the stirring vessel so that the stirring blades are distant from each other; rotating the stirring blades in directions opposite to each other, to mix the poor solvent and the solution of the organic material under stirring; and controlling a state where a liquid is stirred in the stirring vessel.

3. The method of producing organic particles according to claim 2, wherein an external magnet is placed on the outside of the wall of the stirring vessel close to the respective stirring blade, a magnetic coupling having no penetrating axis is formed between the external magnet and the respective stirring blade, and the respective stirring blade is rotated by rotating the external magnet.

4. The method of producing organic particles according to claim 1, wherein the process b includes: providing the stirring zone with a first stirring means and a second stirring means; quickly mixing the poor solvent and the solution of the organic material in the stirring zone with the first stirring means; and immediately making said organic particles formed flow out of the stirring zone with the second stirring means.

5. The method of producing organic particles according to claim 1, wherein the mixing under the condition where a shearing force is applied in the process c is performed with a dissolver stirring machine.

6. The method of producing organic particles according to claim 1, wherein the mixing under the condition where a shearing force is applied in the process c is performed with a stirrer provided with a turbine capable of rotating and an immobilized stator.

7. The method of producing organic particles according to claim 1, wherein the poor solvent for the organic material is a solvent selected from the group consisting of aqueous solvents, alcohol compound solvents, ketone compound solvents, ether compound solvents, ester compound solvents, and mixed solvents thereof.

8. The method of producing organic particles according to claim 1, wherein the good solvent for the organic material is a solvent selected from the group consisting of aqueous solvents, alcohol compound solvents, ketone compound solvents, ether compound solvents, sulfoxide compound solvents, ester compound solvents, amide compound solvents, and mixed solvents thereof.

9. The method of producing organic particles according to claim 1, wherein the organic material is an organic pigment.

10. The method of producing organic particles according to claim 1, wherein the organic particles have a number average particle diameter of 1 μm or less.

11. An apparatus of producing organic particles, in which a solution of an organic material dissolved in a good solvent is mixed with a poor solvent for the organic material, thereby to form particles of the organic material in a resultant liquid mixture, said poor solvent being compatible with the good solvent,
wherein the apparatus has any of the following means A and B:
[A] means comprising: predetermined numbers of liquid feed ports through which the poor solvent and the solution of the organic material dissolved in the good solvent are made to flow, respectively; a liquid discharge port for discharging a liquid that has been subjected to the stirring; and stirring means; and
[B] means comprising: a container capable of containing the poor solvent; a mixing chamber which is provided in the container and the inside of which is capable of being filled with the poor solvent; and stirring means for mixing and stirring the poor solvent and the solution of the organic material fed into the mixing chamber, the stirring means being provided in the mixing chamber.

12. The apparatus of producing organic particles according to claim 11, wherein the stirring means in the means A is a pair of stirring blades, the stirring blades being placed at two opposing sites distant from each other in a stirring vessel, and the stirring blades rotating in directions opposite to each other, to control a state where a liquid is stirred in the stirring vessel.

13. The apparatus of producing organic particles according to claim 12, which has: an external magnet which is placed on the outside of the wall of the stirring vessel close to the respective stirring blade and which forms a magnetic coupling having no penetrating axis with respect to the respective stirring blade; and driving means for rotating the respective stirring blade by rotating the external magnet, the driving means being deployed outside the stirring vessel.

14. The apparatus of producing organic particles according to claim 11, wherein the means B has: a first stirring means for quickly mixing the poor solvent and the solution of the organic material inside the mixing chamber; and a second stirring means for immediately discharging the resultantly-formed organic particles, to the outside of the mixing chamber.

15. The apparatus of producing organic particles according to claim 11, wherein the organic particles have a number average particle diameter of 1 μm or less.

16. A method of producing organic particles, comprising:
mixing a poor solvent for an organic material with a solution of the organic material dissolved in a good solvent, thereby to form particles of the organic material in a resultant liquid mixture, said poor solvent being compatible with the good solvent; and
concentrating the liquid mixture, thereby to obtain the organic particles,
wherein the concentration is conducted by removing (I) a solvent in the liquid mixture or (II) a solvent of a concentrated extract liquid obtained by concentrating and extracting the organic particles from the liquid mixture with an extraction solvent, by at least one method selected from among centrifugal separation and drying under heat and reduced pressure.

17. The method of producing organic particles according to claim 16, wherein the organic particles have a number average particle diameter of 1 μm or less.

18. The method of producing organic particles according to claim 16, wherein the poor solvent for the organic material is a solvent selected from the group consisting of aqueous solvents, alcohol compound solvents, ketone compound solvents, ether compound solvents, ester compound solvents, and mixtures thereof.

19. The method of producing organic particles according to claim 16, wherein the good solvent for the organic material is a solvent selected from the group consisting of aqueous solvents, alcohol compound solvents, ketone compound solvents, ether compound solvents, sulfoxide compound solvents, ester compound solvents, amide compound solvents, and mixtures thereof.

20. The method of producing organic particles according to claim 16, wherein the extraction solvent is an ester compound solvent.

21. The method of producing organic particles according to claim 16, wherein the organic material is an organic pigment.
